(19) United States
(12) Patent Application Publication
(10) Pub. No.: US 2025/0059882 A1
(43) Pub. Date: Feb. 20, 2025

(54) DEPTH MEASUREMENT WITHIN A BOREHOLE

(71) Applicant: Imdex Technologies Pty Ltd, Balcatta, Western (AU)

(72) Inventors: Chris Koplan, Elizabeth, CO (US); Wayne Hay, Balcatta (AU); Matthew White, Balcatta (AU); Fred Blaine, Balcatta (AU)

(21) Appl. No.: 18/720,248

(22) PCT Filed: Dec. 22, 2022
(86) PCT No.: PCT/AU2022/051577

§ 371 Date: Jun. 14, 2024

(30) Foreign Application Priority Data
Dec. 23, 2021 (AU) 2021904223

(51) Int. Cl. E21B 47/04; E21B 47/024; G01P 15/08; G01P 15/14; G01P 21/00

(52) U.S. Cl. CPC E21B 47/04; E21B 47/024; G01P 21/00; E21B 2200/20; G01P 15/0802; G01P 15/14

(57) ABSTRACT

A measurement device (MD) for measuring depth within a borehole comprising a sensing component including, at least, a plurality of accelerometers configured to generate accelerometer data as the MD moves through the borehole. The MD further comprises a controller component configured to correct the accelerometer data generated by the sensing component by: repeatedly, for each of a plurality of movement periods in which the MD moves within the borehole: altering the accelerometer data generated during the movement period to reduce errors associated with the movement of the MD, based on the accelerometer data generated in at least one of a first stationary period of the MD and a second stationary period of the MD, the first and second stationary periods occurring respectively before and after the movement period, wherein each of the plurality of movement periods corresponds to extraction of a portion of the drill string from the borehole.

### TECHNICAL FIELD

The present invention relates to systems, methods and devices for performing measurements of the depth of an instrument within a borehole, and specifically to improving the accuracy of values obtained from inertial data produced by a measurement device that is moved through the borehole during the drilling workflow.

### BACKGROUND

The term “borehole” is used to collectively refer to any of the various types of holes that may be drilled into a ground surface, whether above ground or underground, for example in order to perform resource exploration or geotechnical investigation or assessment of a site, such as a mine site, to enable the collection of soil samples, water samples or rock cores, or to install monitoring wells or piezometers.

It is often desirable to determine an indication of the depth of a measurement device disposed within the borehole at different locations (referred to as the “borehole depth” of the device). Borehole depth measurements are particularly important in order, for example, to not only determine the final depth of the hole (i.e., when the device is located at the end position of the borehole), but also to determine the depths of the device as it moves within the borehole over time, for example during a process of carrying out other measurements.

For example, depth measurement data may be used to provide an indication of the depths at which particular geological features of strata and/or formation surrounding the borehole occur (e.g., the occurrence of mineral deposits) during a geological survey of the borehole. In this case, the ability to produce accurate depth measurements facilitates an improved modelling, including location, of geological information of the strata in and/or surrounding the vicinity of the borehole. This information is useful for example in green fields exploration or where exploratory holes have been drilled. This can then allow a more accurate determination of a suitable location for a mine site.

Once a particular area of interest has been identified, then for example, performing logging (i.e., the recording of geological survey data) for many boreholes across a particular area of interest enables the creation of a model of the sub-surface (formation/strata) in terms of its geological properties. Specifically, this data provides a picture of the sub-surface geology in the area of interest. This geological model can feed into a geological block model that defines a particular area of interest (e.g. to be mined, within the larger area) and thereby provides utility for assessing the subsurface and each individual borehole within (such as by assisting with increased efficiencies in planning and operating a mine site).

For example, the existence of highly accurate and comprehensive hole logging data and/or in combination with other information obtained from, for example, “measurement while drilling” (MWD) or “logging while drilling” (LWD) sources enables more informed decisions to be made as there is now greater information in relation to, for example, the waste/ore boundaries, identification of grades of minerals etc., that then enables increased efficiencies to be obtained. For example, in some cases an explosives loading plan may be modified to take account of the waste/ore boundaries, where the waste material is of a larger blast size than the ore, leading to improved blast efficiencies and yields.

One approach to depth measurement involves the use of data provided by a deployment mechanism configured to deploy the measurement device into the borehole. For example, a depth encoder may provide an indication of a length of cable deployed to lower the measurement device to a particular position. The indications of depth provided by the encoder are logged against parameter measurements determined by the measurement device. These systems are typically reliant on a constant connection between the deployment mechanism and the measurement device (referred to as “wireline” approaches).

Another approach involves the use of a measurement device that includes inertial sensing devices, such as gyroscopes and accelerometers, configured to generate inertial data of the measurement device as it moves through the borehole. The inertial data is processed to generate estimates of the velocity and position of the measurement device, enabling the measurement device to produce measurements of its own depth within the borehole without a wireline connection.

### SUMMARY

There is provided a measurement device (MD) for measuring depth within a borehole when coupled to a drill string disposed within the borehole, the MD comprising: a sensing component including, at least, a plurality of accelerometers configured to generate accelerometer data as the MD moves through the borehole; and a controller component configured to: correct the accelerometer data generated by the sensing component by: repeatedly, for each of a plurality of movement periods in which the MD moves within the borehole: altering the accelerometer data generated during the movement period to reduce errors associated with the movement of the MD, based on the accelerometer data generated in at least one of a first stationary period of the MD and a second stationary period of the MD, the first and second stationary periods occurring respectively before and after the movement period, wherein each of the plurality of movement periods corresponds to extraction of a portion of the drill string from the borehole; and generate, based on the corrected accelerometer data, one or more corresponding corrected depth measurement values of the MD in the borehole.

In some embodiments, the drill string disposed within the borehole comprises one or more interconnected drill rods, and each movement period ends with the extraction of one or more of the drill rods from the borehole.

In some embodiments, the accelerometer data is corrected incrementally for each successive movement period of the plurality of movement periods when the MD comes to rest during the second stationary period.

In some embodiments, the corrected depth measurement values are generated from a plurality of displacement values of the MD, wherein the displacement values are generated incrementally for each successive movement period after the corresponding correction of the accelerometer data.

In some embodiments, each movement period is determined by processing the accelerometer data generated by the MD in a signal window to determine one or more statistical metrics indicating one or more time periods of relatively low accelerometer output.

In some embodiments, determining each movement period includes: obtaining output data from an accelerometer of the MD; calculating one or more statistical metrics derived from a window of the output data; determining a quiet period of the output data by comparing the calculated one or more statistical metrics to one or more corresponding predetermined values; determining one or more null estimate values of the accelerometer by processing the output values of at least the determined quiet period; determining an indication of movement of the MD by applying the null estimate value to correct the output data; and in response to a change in the indication of movement over time, determining a start time or an end time of the respective movement period.

In some embodiments, altering the accelerometer data includes performing velocity error compensation to generate adjusted accelerometer data to cause corresponding velocity data to indicate that the MD is stationary at the end of the movement period.

In some embodiments, performing velocity error compensation includes: (a) determining, based on accelerometer data during the movement period, a non-zero velocity of the MD at the end of the movement period; (b) incrementally adjusting the accelerometer data to cause a corresponding adjustment of an indication of the velocity during, and at the end of, the movement period; and (c) iteratively repeating steps (a) and (b) until the velocity of the MD at the end of the movement period is zeroed.

In some embodiments, altering the accelerometer data includes determining an indication of gravity from the accelerometer data determined during the first or second stationary periods of the movement period.

In some embodiments, altering the accelerometer data includes compensating for an accumulated error of the accelerometer data by computing a measure of the stable total gravity inclusive of the MD attitude.

In some embodiments, the sensing component further includes a plurality of gyroscopes configured to generate gyroscope data corresponding to the accelerometer data, and wherein the controller component is further configured to: correct the gyroscope data generated by the sensing component by performing one or more of: a) resetting the starting dip angle to that of the stable accelerometer sensed value during the first stationary period; and b) determining a change in the dip angle of the gyroscope data to the corresponding accelerometer data immediately after the movement period, and applying the change in the dip angle ratiometrically to the dip angle values produced by the gyroscope data over the movement period.

In some embodiments, correcting the gyroscope data includes performing attitude error compensation by: determining an accumulated error due to a gyroscope bias induced drift of one or more of the plurality of gyroscopes, based on the difference in attitude values of the corresponding gyroscopes generated in the first and second stationary periods; and retroactively and evenly distributing the determined accumulated error over the gyroscopic attitude values generated during the movement period, such that the resulting gyroscopic attitude values generated just prior to the second stationary period coincide with accelerometer attitude values generated during the second stationary period.

In some embodiments, generating the depth measurement values includes, for each movement period: determining a depth differential value as the difference between respective displacement values generated at the start and the end of the movement period; determining a depth error component by subtracting, from the depth differential value, a length of the corresponding drill rod extracted from the borehole during the movement period; and distributing the depth error component over the movement period.

In some embodiments, distributing the depth error component over the movement period includes: normalizing the depth error component by a number of displacement measurements corresponding to the movement period; and subtracting the normalized depth error component from each displacement measurement value of the movement period.

In some embodiments, each of plurality of accelerometers are configured with different detection capabilities, the detection capability of each accelerometer being defined by one or more of: a dynamic range value; and a bandwidth value, and wherein the accelerometer data is generated, in a time period, by using output data of a first accelerometer of the plurality of accelerometers, the first accelerometer being selected based on the motion experienced by the MD in the time period and the detection capabilities of the plurality of accelerometers.

There is also provided a method for correcting accelerometer data obtained from a measurement device (MD) coupled to a drill string disposed within a borehole, the method comprising: i) determining a movement period in which the MD moves within the borehole; ii) altering the accelerometer data generated during the movement period to reduce errors associated with the substantially linear movement of the MD, based at least on accelerometer data generated in at least one of a first stationary period of the MD and a second stationary period of the MD, the first and second stationary periods occurring respectively before and after the movement period; and iii) repeating (i) and (ii) for one or more further movement periods in which the MD is within the borehole, wherein each of the plurality of movement periods corresponds to extraction of a portion of the drill string from the borehole.

In some embodiments, the accelerometer data is corrected incrementally in real-time or during post processing for each successive movement period of the plurality of movement periods when the MD comes to rest during the second stationary period.

In some embodiments, the corrected accelerometer data is processed to generate one or more corresponding corrected depth measurement values of the MD in the borehole.

In some embodiments, the corrected depth measurement values are generated from a plurality of displacement values of the MD, wherein the displacement values are generated incrementally for each successive movement period after the corresponding correction of the accelerometer data.

In some embodiments, altering the accelerometer data includes performing velocity error compensation to generate adjusted accelerometer data to cause corresponding velocity data to indicate that the MD is stationary at the end of the movement period.

In some embodiments, performing velocity error compensation includes: (a) determining, based on accelerometer data during the movement period, a non-zero velocity of the MD at the end of the movement period; (b) incrementally adjusting the accelerometer data to cause a corresponding adjustment of an indication of the velocity during, and at the end of, the movement period; and (c) iteratively repeating steps (a) and (b) until the velocity of the MD at the end of the movement period is zeroed.

In some embodiments, generating the depth measurement values includes, for each movement period: determining a depth differential value as the difference between respective displacement values generated at the start and the end of the movement period; determining a depth error component by subtracting, from the depth differential value, a length of the corresponding drill rod extracted from the borehole during the movement period; and distributing the depth error component over the movement period.

In some embodiments, distributing the depth error component over the movement period includes: normalizing the depth error component by a number of displacement measurements corresponding to the movement period; and subtracting the normalized depth error component from each displacement measurement value of the movement period.

There is also provided an apparatus for measuring depth within a borehole, including: a measurement device (MD) coupled to a drill string disposed within the borehole; and a data processing device having: a communications interface to receive data from at least the MD; at least one computer processor to execute program instructions; and a memory, coupled to the at least one computer processor, to store program instructions for execution by the at least one computer processor, wherein the MD is configured to: generate, by a sensing component including a plurality of accelerometers, accelerometer data as the MD moves through the borehole; and transmit, to the data processing device, the generated accelerometer data; and wherein the data processing device is configured to: receive the accelerometer data from the MD; and correct the accelerometer data; and generate, based on the corrected accelerometer data, one or more corresponding corrected depth measurement values of the MD within borehole, wherein the correction of the accelerometer data is performed according to any of the methods described herein.

There is also provided a method for obtaining depth registered geological data using a measurement device (MD) coupled to a drill string disposed within a borehole, the method comprising: obtaining, from a geological sensing component of the MD, geological data including one or more geological measurement values of the borehole as the MD moves through the borehole; generating depth data indicating one or more depth measurement values of the MD in the borehole; and registering each of the one or more geological measurement values with a corresponding depth determined from the generated depth measurement values, wherein the generation of the one or more depth measurement values comprises correcting accelerometer data obtained from the MD according to any of the methods described herein.

In some embodiments, generating the depth data comprises: i) determining, via a drill string monitoring device, displacement data indicating one or more displacements of the MD along the axis of the borehole; and ii) determining corresponding depth measurement values of the MD within the borehole from the determined displacements, wherein the displacement data is generated by measuring the movement of the drill string at, or about, a region of a surface of the borehole.

In some embodiments, generating the depth data comprises: detecting, based on the displacement data, one or more movement periods and corresponding stationary periods of the MD within the borehole, wherein each of the movement periods corresponds to extraction of at least a portion of the drill string from the borehole.

In some embodiments, the drill string monitoring device is a LiDAR Distance Gauge System.

In some embodiments, registering each of the one or more geological measurement values with a corresponding depth comprises performing time synchronization of the geological measurement values with the depth measurement values, by matching corresponding movement periods determined during the generation of the geological data and the depth data.

There is also provided an apparatus for obtaining depth corrected geological data of a borehole, including: a measurement device (MD) coupled to a drill string disposed within the borehole; and a data processing device having: a communications interface to receive data from at least the MD; at least one computer processor to execute program instructions; and a memory, coupled to the at least one computer processor, to store program instructions for execution by the at least one computer processor, wherein the MD is configured to: generate, by a geological sensing component, geological data including one or more geological measurement values of the borehole as the MD moves through the borehole; and transmit, to the data processing device, the generated geological data; and wherein the data processing device is configured to: receive the geological data from the MD; and obtain depth data indicating one or more depth measurement values of the MD in the borehole; and register each of the one or more geological measurement values with a corresponding depth determined from the generated depth measurement values, wherein the generation of the one or more depth measurement values comprises correcting accelerometer data obtained from the MD in accordance with any of the methods described herein.

### BRIEF DESCRIPTION OF DRAWINGS

Some embodiments are described herein below with reference to the accompanying drawings, wherein:

FIG. 1a illustrates a desired configuration of a borehole to be drilled, in accordance with some embodiments;

FIG. 1b illustrates performing drilling of the borehole of FIG. 1a with a first plurality of drill rods, in accordance with some embodiments;

FIG. 1c illustrates performing drilling of the borehole of FIG. 1a with a second plurality of drill rods, in accordance with some embodiments;

FIG. 2a illustrates a deployment of a measurement device (MD), by a deployment vehicle, to measure the borehole 101, in accordance with some embodiments;

FIG. 2b illustrates a block diagram of the components of the MD, in accordance with some embodiments;

FIG. 2c illustrates a schematic representation of a particular implementation of the MD components of FIG. 2b, in accordance with some embodiments;

FIG. 2d illustrates a schematic representation of a depthing module of the MD of FIG. 2a, in accordance with some embodiments;

FIG. 3 illustrates a flow diagram of a method for measuring the depth of a borehole, in accordance with some embodiments;

FIG. 4a is a first schematic diagram illustrating the movement of the MD of FIGS. 2a-d during a drill string extraction process, in accordance with some embodiments;

FIG. 4b is a second schematic diagram illustrating the movement of the MD of FIGS. 2a-d during a drill string extraction process, in accordance with some embodiments;

FIG. 4c is a third schematic diagram illustrating the movement of the MD of FIGS. 2a-d during a drill string extraction process, in accordance with some embodiments;

FIG. 4d is a fourth schematic diagram illustrating the movement of the MD of FIGS. 2a-d during a drill string extraction process, in accordance with some embodiments;

FIG. 4e is a fifth schematic diagram illustrating the movement of the MD of FIGS. 2a-d during a drill string extraction process, in accordance with some embodiments;

FIG. 4f is a sixth schematic diagram illustrating the movement of the MD of FIGS. 2a-d during a drill string extraction process, in accordance with some embodiments;

FIG. 4g is a seventh schematic diagram illustrating the movement of the MD of FIGS. 2a-d during a drill string extraction process, in accordance with some embodiments;

FIG. 4h is a eighth schematic diagram illustrating the movement of the MD of FIGS. 2a-d during a drill string extraction process, in accordance with some embodiments;

FIG. 5 is a timing diagram illustrating the movement of the MD of FIGS. 2a-d during a drill string extraction process, in accordance with some embodiments;

FIG. 6a illustrates a sub-process for accelerometer data error correction in the method of depth measurement of FIG. 3, according to the described embodiments;

FIG. 6b illustrates a sub-process for determining the movement period MP for accelerometer data error correction in the method of depth measurement of FIG. 3, according to the described embodiments;

FIG. 6c illustrates a sub-process for performing velocity error compensation in the method of accelerometer data error correction of FIG. 6a, in accordance with some embodiments;

FIG. 7 illustrates a sub-process for performing relative error compensation in the method of accelerometer data error correction of FIG. 6a, in accordance with some embodiments;

FIG. 8 illustrates a graph of an exemplary velocity function obtained from integrating the exemplary relatively compensated accelerometer values, in accordance with some embodiments;

FIG. 9 illustrates a sub-process for the generation of corrected depth measurements in the method of depth measurement of FIG. 3, according to the described embodiments;

FIG. 10a illustrates a first sub-process for performing error bounding in the method of generating corrected depth measurements of FIG. 9, in accordance with some embodiments;

FIG. 10b illustrates a second sub-process for performing error bounding in the method of generating corrected depth measurements of FIG. 9, in accordance with some embodiments;

FIG. 11 illustrates a flow diagram of obtaining depth registered geological data using a measurement device coupled to a drill string disposed within a borehole, in accordance with some embodiments; and

FIG. 12 illustrates a sub-process for generating one or more depth measurement values in the method for obtaining depth registered geological data of FIG. 11, in accordance with some embodiments.

### DESCRIPTION OF EMBODIMENTS

In this specification and claims, except where the context requires otherwise due to express language or necessary implication, the following definitions apply.

“Bore hole”, “hole” and “Borehole” refer to a hole drilled by a drill rig in a formation or area of interest or bench which is to be surveyed.

“Surveying” (of a borehole) refers to the process of determining measurements of one or more parameters of the borehole by a measurement device, as the measurement device is moved through the borehole, along its axis, over time.

“Geological surveying” refers to the process of determining geological data indicating, for example, the mineralogical, structural, or physical characteristics of the formations penetrated by a borehole, using a geo-sensing component of the measurement device.

“Geological data” refers to any one or more of the following types of geological data relating to geophysical, petro-physical, mineralogical, hole geometry, chemistry and/or compositional data of the borehole itself, and/or of material in and/or surrounding strata/formation of the borehole itself.

“Directional surveying” refers to the process of determining navigational data indicating the course of, and the current position of, the measurement device.

“Borehole depth” refers to the depth within a borehole of a reference device, the depth being an indication of the substantially linear distance between the position of the device, and a collar position of the borehole, along the axis of the borehole.

“Borehole depth measurement (process)” is the process of determining an indication of the borehole depth of a measurement device at one or more time instants (typically as the measurement device is moved through the borehole).

“Navigational data” refers to data representing the trajectory of the measurement device over time as it moves through the borehole as determined from a directional survey, including an indication of the azimuth, dip and borehole depth of the device.

“Inertial data” refers to data representing measurements obtained by inertial sensors (e.g., accelerometers and gyroscopes) of an inertial sensing component of a measurement device moving through the borehole, for example the angular rate and acceleration of the device.

“Logging” refers to the storage of data measured during a surveying process of a borehole, where the storage occurs either within the measurement device obtaining the measurements (“on-device”) (e.g., when a wireline is not used), or on another device (“off-device”) (e.g., when a wireline is used to transmit the measured data to another device at the surface).

“Surface” refers to the top of the ground/formation and/or area of interest including, but not limited to, whatever earth, soil, or land that lies above superincumbent upon or about the collar of the borehole.

“Sub-surface” refers to the region below the surface including, but not limited to, the collar of the borehole into which the borehole (cavity) extends.

“Collar” (of a borehole)—the mouth or opening of the borehole onto the surface, typically created by a drilling operation carried out by a drill rig.

The accuracy of depth measurements produced by inertial sensing (i.e., the determination of parameters describing the motion of the measurement device) is dependent on the accuracy of the measured data. However, imperfections in the sensors may lead to errors in the data (e.g., the acceleration values) that are produced by the measurement device. The presence of these errors cannot always be mitigated by the use of improved sensor hardware since there is a limit to the accuracy of the parameter estimates that are obtainable with a particular sensor configuration before it becomes prohibitively expensive, or otherwise impractical, to construct a measurement device that satisfies the accuracy requirements sought for borehole surveying applications.

An additional concern is the tendency of errors in sensors, such as accelerometers and gyroscopes, to result in an increase in attitude and depth measurement errors over time, typically referred to as “drift”. That is, even if errors produced by such a measurement device are initially small, these errors, when integrated, are likely to become significant over time leading to large inaccuracies towards the end of the process (particularly for a borehole with a long axial length).

Another difficulty faced by measurement devices that utilize accelerometers is the variation in the true local gravity value. The value of the acceleration due to gravity varies in different locations, and these fluctuations may be large enough to cause a corresponding variation in resulting inertial distance measurements determined at the different locations. As a result, there is a need for more precise gravity modelling than, or at least to apply compensation techniques to, the simple gravity models used by some prior art systems.

A further issue encountered by systems with inertial devices in dynamic environments is that of transient sensor errors. Transient sensor errors may result from motion experienced by the sensor that exceeds the range of frequencies and magnitudes over which the sensor is able to produce accurate results. Transient sensor errors occur over a relatively short time period but can be of much larger amplitudes than drift and gravity errors resulting in significant inertial distance measurement errors. Since transient errors occur during motion, they cannot easily be distinguished from the motion itself. Transient errors may accumulate with other errors, such as errors due to drift and imprecise gravity modelling, such that the resulting total error in the inertial distance measurements are a composite of these errors.

Some approaches to reducing such errors include modifying the measurement device to incorporate shock and vibration isolation mounting components, or to use individual sensors that are specifically configured to detect the transient values. For example, one or more shock insulating or dampening components may be applied to the exterior of the measurement device (e.g., to the housing) or internally within the device (e.g., to encase particular sensors) to reduce or eliminate the effects of shock and vibration. Despite this, there exists a need for methods to identify the existence of, and compensate for the effects of, transient sensor errors in the depth measurements produced by a measurement device that utilizes inertial sensing.

Conventional approaches to overcoming the inaccuracies of inertial sensors, such as accelerometers, involve the use of additional information to compensate for the errors in, or otherwise complement, the measurements. For example, some systems rely on data provided by a depth encoder (e.g., indications the physical length of cable deployed) to resolve depth estimates generated from the sensor values. However, this results in a reliance of the depth measurement process on a surface based deployment mechanism. This also has an undesirable effect of limiting the workflow that is available for the logging (e.g., since the logging must be performed at a time in the workflow when the deployment mechanism can be operated).

Another approach to improving conventional inertial measurements is to utilize navigation data provided by another system. For example, improved navigation accuracy may be achieved through the use of a position fixing navigation aid, such as data from a Global Positioning System (GPS) satellite, thereby enabling the drift errors to be bounded. However, there are also problems with this approach, including the inability of most fixed position based navigation systems to reliably deliver data to a measurement device located below the ground surface (i.e., deep within a borehole).

Specifically, some systems attempt to overcome errors in depth measurements by correcting the inertial velocity, as calculated from the average velocity computed from the known drill rod length transit time (i.e., the time taken by the measurement device to pass through the hollowed rod). However, this approach relies on the detection of the drill string joints (i.e., indicating the start and end of each particular drill rod), and therefore introduces another potential source of error (i.e., the possibility of failing to detect a joint, or registering a false positive detection). More importantly, this average velocity correction cannot be used to obtain the instantaneous depth. For example, if the instantaneous velocity varies, or even reverses, the instantaneous depth change at any given time will vary and not stay constant.

Furthermore, the probe is guided through the borehole, when cased by the drill string, such that the motion of the probe facilitates the detection of the drill rod segments as the probe passes each (drill rod section) coupling. This has some significant implications, namely that: i) the error correction must be performed while the entirety of the drill string is in place within the borehole; ii) a wireline mechanism is required to move the probe through the drill string, either from a position seated at the bottom of the drill string or after the probe is dropped and allowed to fall freely within the drill string. Such approaches to inertial error correction favour a single continuous motion of the probe over the entire borehole length (i.e., without stopping the probe); and iii) as the probe passes is required to pass through the interior of the drill string during the process, measurement of geological data by the probe may be subject to interference (i.e., due to the material of the string casing) thereby limiting the utility of the probe for obtaining such data.

Significantly, this is not suited to applications where it is desired to produce corrections to the estimated depths constantly and in real-time as the measurement tool travels through the borehole. This may be the case, for example, when the measurement device is configured to also generate measurements of geological data periodically as the device traverses the borehole (i.e., where the depth measurements may be performed while the measurement device is in motion).

It is desired to develop an apparatus and methods that address one or more of these problems, or that at least provide a useful alternative.

### Overview

Described herein are embodiments of devices, apparatus, and methods for providing improved depth measurements of a borehole 101 by correcting inertial data, including at least accelerometer data, obtained from a measurement device moving through the borehole 101, and based on the workflow associated with the extraction of a drill string 146 from the borehole 101. That is, correction is performed on inertial data obtained from a measurement device (MD) 104 incrementally for one or more periods in which the MD 104 experiences movement and/or motion within the borehole, where the movement and/or motion is substantially parallel with, and/or along, the axis or centre line of the borehole. This enables the correction of errors in the inertial data in real-time as the MD 104 moves between respective stationary periods, and where the movement of the MD 104 is determined by the workflow of extracting the drill string 146 from the borehole 101.

It will be apparent to the skilled addressee that geological data includes any one or more of the following types of geological data relating to geophysical, petro-physical, mineralogical, hole geometry, chemistry and/or compositional data of the borehole itself, and/or of material in and/or surrounding strata/formation of the borehole itself. These geological data measurements include, but are not limited to, any one, or a combination of any one or more of the following: gamma radiation emitted by material in and/or surrounding strata/formation of the hole, density of material in and/or surrounding strata/formation of the hole, reflectivity (reflection, absorption or transmission) of electromagnetic radiation, reflectivity (reflection, absorption or transmission) of acoustic or ultrasonic waves, magnetic susceptibility of material in and/or surrounding strata/formation of the hole, electrical resistivity/conductivity/impedance of material in the hole, magnetic vector field, hole dip, hole wall temperature, sonic velocity, contact hardness, hole azimuth, hole diameter, hole profile, hole volume and/or water level. Such geological measurements can be collected by the appropriate sensor.

Generally disclosed are embodiments of a method for determining the depth of a measurement device (MD) within a borehole 101, including: i) correcting accelerometer data generated by a plurality of accelerometers of the MD 104 disposed within the borehole 101 by repeatedly, for each of a plurality of movement periods in which the MD 104 moves within the borehole 101: altering the accelerometer data generated during the movement period to reduce errors associated with the movement of the MD, based on the accelerometer data generated in at least one of a first stationary period and a second stationary period, occurring respectively before and after the movement period, in which the MD is stationary; and ii) generating, based on the corrected accelerometer data, one or more corresponding corrected depth measurement values of the MD 104 within the borehole 101. The MD 104 is coupled to a drill string 146, such that each of the plurality of movement periods corresponds to the extraction of a portion of the drill string 146 from the borehole 101. The measurement apparatus, and/or device 104, may include one or more computer systems, devices, or components configured to execute computer-implemented instructions to perform the method steps (i) and (ii) described herein.

Borehole 101 is formed according to a drilling workflow in which a drill string 146 is disposed within the borehole 101, and where the drill string 146 is comprised of a plurality of interconnected drill rods 146a-c. In the described embodiments, the incremental correction of the accelerometer data occurs over successive movement periods corresponding to the removal of an individual drill rod 146a-c from the drill string 146. That is, the described methods and devices perform a correction of measurements taken by the MD by utilizing the specific workflow of the extraction of a drill string 146 following the drilling of the borehole 101. The correction of the accelerometer data thereby occurs incrementally over time based on a series of stationary periods experienced by the MD 104 during the extraction.

In the described embodiments, the sensors of sensing component 126 include at least a plurality of accelerometers configured to periodically generate accelerometer data, including indications of acceleration of the MD 104, at sample instants as the MD 104 traverses the borehole 101 during a depth measurement process. The accelerometer data generated by the sensing component 126 is corrected, incrementally over the plurality of movement periods, to reduce errors associated with the substantially linear movement of the MD 104 along an axis X or centre line of the borehole 101 (i.e., as the MD is moved through the borehole in accordance with the drill string extraction process).

Correspondingly corrected depth values may be generated from displacement values derived from the corrected accelerometer data (e.g., by performing double integration of the corrected acceleration values to determine the linear distance travelled by MD 104 along the axis of the borehole). That is, the methods, devices and apparatus described herein compensate for the errors that may occur in accelerometer measurements of a measurement device moving within a borehole, resulting in the generation of corresponding depth measurements of the borehole that have improved accuracy over the prior art. In other aspects, the depth of the MD 104 is determined by correcting data associated with or derived from the accelerometer data, such as for example accelerometer derived velocity or displacement data. This is advantageous in avoiding the need to re-integrate the accelerometer data values post-correction (or corrected velocity values in the event of a displacement correction).

In the described embodiments, correction of the accelerometer data is performed by the application of: relative compensation (i.e., to compensate for accumulated errors in the acceleration values directly); and velocity error compensation to generate adjusted accelerometer data to cause corresponding velocity data to indicate that the MD 104 is stationary at the end of the associated movement period. In one implementation, velocity error compensation involves iteratively: determining, based on the accelerometer data during the movement period, a non-zero velocity of the MD 104 at the end of the movement period; and incrementally adjusting the accelerometer data values to cause a corresponding adjustment of the velocity values during, and at the end of, the movement period.

In other embodiments, the sensing component 126 of the MD 104 also includes a plurality of gyroscopes 129 configured to generate gyroscope data, such as for example an indication of the angular velocity and, when integrated, change in attitude of the MD 104 which allows for more accurate compensation of the component of gravity included in the accelerometer data. In such embodiments, the correction of the accelerometer data includes optionally performing relative compensations to errors in the gyroscope data (e.g., by performing dip angle error compensation or attitude error compensation). Correcting errors in the gyroscope data, and applying the resulting compensations, improves the accuracy of the corrected depth values for periods of non-substantially linear motion of the MD 104 (i.e., when the borehole 101 geometry is not straight and gyroscope measurements are significant to resolve the attitude of the MD 104 within the borehole 101 and with respect to gravity).

In the described embodiments, the accelerometer data is corrected incrementally for successive periods of movement of the MD (“movement periods”), as determined to exist between periods in which the MD 104 is stationary. The correction of the accelerometer data for each successive movement period enables the generation of displacement values, and the subsequent generation of corrected depth measurements (referred to as the “corrected depths” of the MD 104 within the borehole 101). In some embodiments, the corrected depths may be generated in real-time when the MD 104 is at rest in the stationary period occurring after the movement period. In other embodiments, some or all of the corrected depth measurements are generated as a post-processing operation following the measurement process, either by the MD 104 (“on-device”) or by another device (“off-device”).

In the described embodiments, the stationary periods correspond to the removal of a drill rod 146a-c from the drill string (“rod removal periods”). In this context, “removal” of a drill rod refers to the process of detaching the drill rod 146a-c from the drill string 146 following the extraction of the rod length from the borehole 101 (i.e. according to the normal drilling workflow).

In such implementations, a movement period of the MD 104 can be non-continuous. That is, the MD 104 may be stationary for one or more “intermediate” periods between successive rod removal periods corresponding to the detachment of a drill rod (e.g., where the extraction of the drill string is paused or becomes stuck). In some embodiments, correction of the inertial data is performed relative to the stationary periods of the MD 104, irrespective of whether the stationary period is an intermediate or a detachment period (e.g., in an ad-hoc manner, or in response to an error correction directive).

The techniques described herein are advantageous in that the measurement device 104 is typically a geological logging tool configured to generate geological measurement data of the borehole 101 in response to its deployment (e.g., as part of a geological survey). Accordingly, the generation of corrected depth measurements facilitates the ability to link identified geological data (e.g., mineral deposits, faults, density and/or other related features) to a particular position along the length of the borehole with improved accuracy, thereby enabling the generation of improved geological information.

Furthermore, the depth measurements are obtained during the process of extracting the drill string 146 from the borehole 101. Accordingly, there is no requirement of the use of an external wireline, or similar deployment mechanism, to facilitate the movement of the MD 104 (i.e., its motion through the borehole 101 is joined, or “fitted”, to the existing workflow). Fitting to the existing drilling workflow provides time and cost advantages. Specifically, the described techniques advantageously utilize the drill rod retrieval process (i.e., involving the removal of the rod from the hole and detachment of the rod from the string), which practically requires that the drill string 146 remain stationary for a time period while individual rods are sequentially detached from the string. This enables the incremental correction of inertial data, and the generation of corresponding depth measurements, automatically in real time by the MD 104, or by an external device.

Also disclosed is a method for obtaining depth registered geological data using a measurement device (e.g., MD 104) coupled to a drill string disposed within a borehole 101, including: i) obtaining, from the MD 104, geological data indicating one or more geological measurement values of the borehole 101 as the MD 104 moves through the borehole; ii) generating depth data indicating one or more depth measurement values of the MD 104 in the borehole 101; and iii) registering each of the geological measurement values with a corresponding depth determined from the generated depth measurement values. Significantly, the generation of the one or more depth measurement values is enabled by the extraction of the drill string from the borehole 101.

That is, the methods and systems referred to above for determining corrected depths are an example of one approach for generating depth measurements for correlation with geological measurements generated by a measurement device (i.e., where the measurement device is also configured to generate geological data). In other examples, the depth measurements may be generated by a device other than the MD 104. The depth measurements may be corrected depths, or raw depth values, as determined from utilization of the drill string extraction workflow.

In the described embodiments, a geological sensing component of the MD 104 is configured to generate the geological data. The generation of depth corrected geological data is performed by a geological analysis device, which may be configured as a standalone computing device located as part of the drilling rig, as a component of the MD 104, or as an external computing device configured to communicate with the drilling rig and/or MD 104 via a communications network.

In the described embodiments, the generated depth measurement values are corrected depth measurement values representing true displacements of the MD 104 along the axis of the borehole 101 as the MD 104 moves through the borehole 101 during the extraction of the drill string. In some embodiments, the depth measurement values are generated via the processing of corrected accelerometer data obtained from the MD 104 (i.e., where the accelerometer data is generated and processed by the MD 104 as described herein).

In other embodiments, the depth measurement values are generated by the direct measurement of one or more displacements of the MD 104 along the axis of the borehole 101. For example, the generation of the depth values may be performed by a drill string monitoring device which measures the movement of the drill string at the collar of the borehole 101 and determines the displacements of the drill string which result. In some embodiments, the displacement data is processed to detect movement and/or stationary periods of the MD 104 within the borehole 101.

In the described embodiments, the MD 104 is configured to generate geological data including geological time values representing sample instants at which geological measurements are performed. The geological analysis device is configured to correlate geological data with depth data, where the depth data includes corresponding depth time values representing sample instants at which corrected depth measurements are performed, in order to obtain the “depth registered” geological data.

The registration (or association) of determined geological measurement values with depth values is performed as a time synchronization process, for example to account for differences in the sampling rate of the two data sets. Exemplary synchronization operations involve absolute synchronization of the time sample values (e.g., where the time samples are produced according to a common reference starting time value), or relative synchronization involving matching corresponding movement periods of the MD 104 determined during the generation of the data sets.

### Borehole Drilling Workflow

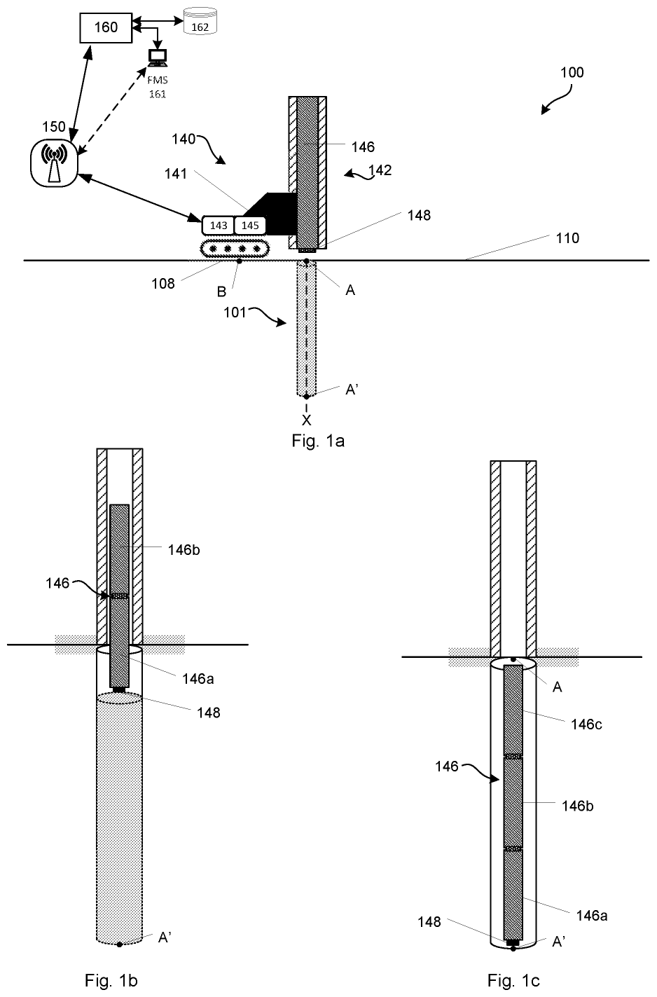

FIGS. 1a, 1b, and 1c together illustrate an exemplary process of drilling one or more boreholes at a site 100, such as a mine site. This process is part of the “drilling workflow” associated with borehole 101. FIG. 1a shows the desired configuration of a borehole 101 to be drilled at a position A on surface 110, as depicted in a pre-drilling state (i.e., prior to creation of the borehole 101).

Although FIG. 1a illustrates the application of the proposed techniques to an above ground mining site, this can be extended to other situations where there is a need to log a borehole after it has been drilled. The borehole 101 is created by a drilling apparatus 140 comprising a drill rig 141 configured to position and control the operation of a drilling device 142 including a drill string 146 with a drill bit 148 attached at the end of the drill string 146 that carries out the drilling.

In some embodiments, the drilling rig 141 is configured to receive hole pattern data representing a desired configuration of the one or more holes, including borehole 101, to be drilled by drill rig 141 on the surface 110. The hole pattern data is provided to the drill rig 141 prior to the commencement of drilling of borehole 101, such as by a data exchange with a computing system included within an operating platform 160. The operating platform 160 may include one or more computing systems configured to perform data storage and/or processing operations on data related to the borehole 101. In some embodiments, the operating platform 160 is configured to exchange data with one or more external systems, such as for example a Fleet Management System (FMS) 161 and/or a data storage system 162.

In some embodiments, borehole 101 is specified by hole pattern data, typically in conjunction with one or more other boreholes located on the site 100. It is typically desired to record measurements (or perform “logging”) of one or more of the boreholes specified in the hole drilling plan after the drilling workflow is complete. The hole pattern data may include location data representing desired hole locations for each hole, including borehole 101, and navigation data to navigate the drill rig 141 to the vicinity of the desired hole locations.

In some embodiments, the hole pattern data also includes operation data enabling the drilling of borehole 101, in response to the rig 141 arriving at position B on surface 110 enabling the hole to be formed at, or close to, the desired hole location for borehole 101 (i.e., location A).

In the described embodiments, the drilling device 142 is a borehole drill including a drill string 146 and a drill bit 148. The drill string 146 is formed as a set of one or more drill rods, where each rod is hollow and of a pre-specified length. Initially, prior to the commencement of drilling, the drill string 146 is formed from a single drill rod 146a. Drill bit 148 is fitted to a distal end of drill rod 146a and the drill string 146 is positioned to such that the drill bit 148 engages the surface 110 at position A.

The drill string 146 rotates the drill bit 148 causing the device 142 to excavate material from beneath the ground of the surface 110 to form a hole 101. During the drilling process the drill string 146 is extended by the sequential connection of additional drill rods onto the proximal end of the string 146. That is, in response to the entirety of the drill string 146 being disposed within the hole 101, the rotation of the drill bit 148 is stopped. As shown in FIG. 1b, a new drill rod 146b is then added onto the string 146 (i.e., via the attachment of the distal end of rod 146b to the proximal end of rod 146a), and drilling recommenced with the drill string of newly extended length. This process of stopping drilling, adding a new drill rod to the drill string 146, and restarting the rotation of the drill bit 148 is repeated until the string 146 reaches a maximum length and/or one or more metrics of the borehole 101 (as specified by the hole pattern data) are met.

As shown in FIG. 1c, the drill string 146 is extended to comprise an interconnected chain of three drill rods 146a, 146b and 146c. The hole 101 extends into the ground at the first position A and terminates at a second position A′ forming the as drilled borehole 101. At the completion of the excavation of the borehole 101 (i.e., once the end of the hole 101 is formed at the second position A′), the drill string 146 is disposed within the borehole 101, such that drill bit 148 resides at the hole end position A′.

In some embodiments, the drilling device 142 is configured to obtain hole drilling data during the drilling of borehole 101. That is, the hole drilling data represents the borehole 101 as drilled by the drilling device 142. In some embodiments, the hole drilling data indicates a configuration of the borehole 101 as a set of as drilled hole parameters including, at least, a collar position (A) indicating a location of the collar of the borehole 101.

In response to the completion of the drilling, the drilling device 142 records one or more properties of the borehole 101, such as for example the collar position, within the hole drilling data. In some embodiments, the drill rig 141 uploads the hole drilling data to the operating platform 160 for storage and/or processing, as shown in FIG. 1a. In other embodiments, the drill rig 141 uploads the data to one or more external systems such as fleet management system (FMS) 161 or data storage system 162. The upload may be performed via an intermediate communications network 150, such as the Internet or another wide area network. Alternatively, the hole drilling data may be transmitted from the one or more computer devices of the drill rig 141 to the operating platform 160, and/or to the one or more external systems, via direct connection (e.g., via the connection of a local storage device, or via an Ethernet based local area network transfer).

Returning to FIG. 1c, a post-excavation state of the borehole 101 is shown, where the desired hole depth has been reached and/or the drilling process cannot be carried out any further, where the core tube of the drilling device 140 has been removed, but where the drill string 146 remains disposed within the borehole 101. As a final step of the drilling workflow, the drill rig 141 (omitted in FIG. 1c) performs a drill string extraction operation to remove the string 146 from the borehole 101. The depth measurement methods described herein below utilize the process of extracting the drill string 146 from the as drilled borehole 101.

### Measurement Device and Depth Logging

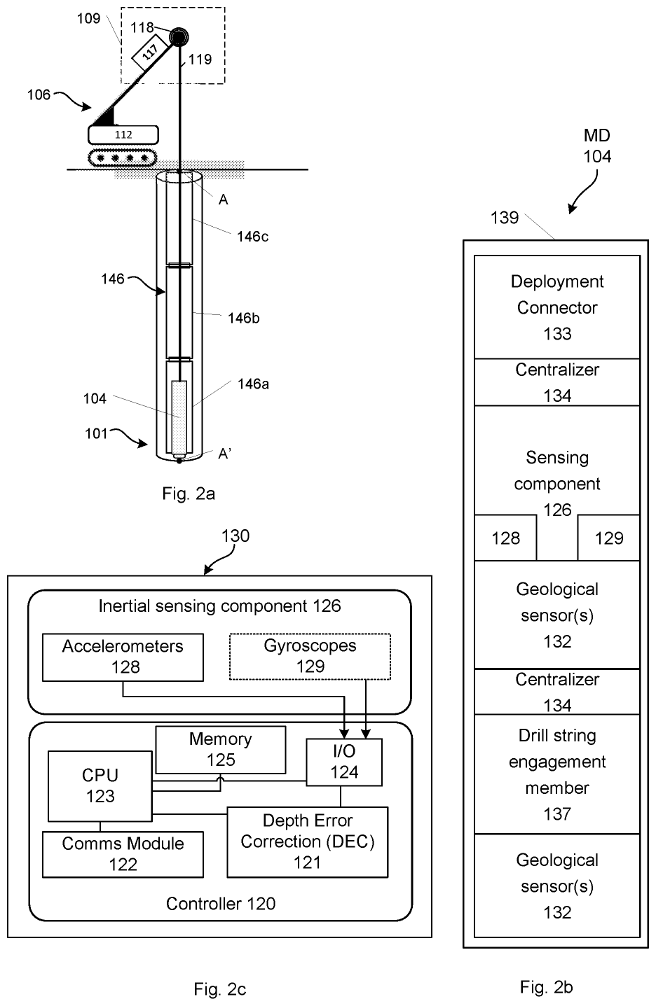

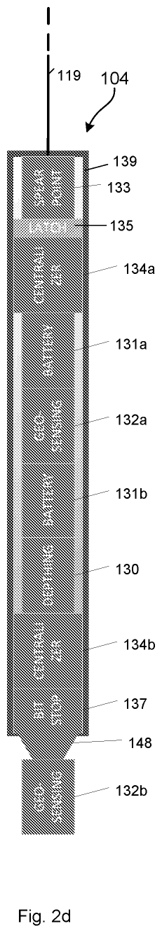

FIG. 2a illustrates the deployment of one embodiment of a measurement device (MD) 104, by a deployment vehicle 106, to measure the borehole 101. The deployment vehicle 106 may be the drilling rig 141, or another special purpose vehicle, configured to deploy the MD 104 into the borehole 101 via a deployment mechanism 109. Before deployment of the MD 104, the drill string 146 may in some instances be lifted off the toe of the hole 101 (i.e., such that a small gap exists between the end of the borehole 101 at A′ and the end of the string 146). The deployment mechanism 109 may include, for example: a wireline 119 provided with an overshot that can engage with the spearpoint on the head of the MD 104; and a winch 118 adapted to the wireline 119 to lower the MD 104 down the borehole 101. In the described embodiments, the deployment vehicle 106 is the drill rig 141 operated by a driller, and the deployment and initialization of the MD 104 is performed by the driller according to the processes described below.

In some embodiments, the deployment mechanism 109 includes a depth logging device 117 configured to quantify the deployment of the measurement device 104. For example, in some embodiments the depth logging device 117 is an encoder configured to measure an amount of wireline used to deploy the MD 104 downhole. In some aspects, the encoder 117 includes digital or analogue circuitry adapted to count successive length values corresponding to indications of the wireline 119 presently deployed. In other aspects, the encoder 117 is a mechanical device configured to read one or more physical properties of the wireline 119 to determine the length. In some aspects, the mechanical device operates by processing one or more measurement units included along the wireline 119 length.

The deployment vehicle 106 lowers the MD 104 into the borehole 101 in the post-excavation state (i.e., where the hollowed drill string 146 is disposed within the borehole 101, as previously shown in FIG. 1c). Wireline 119 is attached to the MD 104, and the deployment mechanism 109 is activated to cause the MD 104 to be lowered into the borehole 101.

In some embodiments, lowering of the MD 104 through the borehole 101 is achieved by gravity. In other embodiments, the MD 104 is deployed into the borehole 101 without use of a wireline. Once the MD reaches the bottom of the drill string, the MD 104 may, for example, be installed in the core barrel innertube assembly of a drill rod 146a in advance of deployment in the string 146. In another example, the MD 104 is pushed down near to the toe of the hole 101 at position A′ by the activation of a pump configured to apply fluid pressure as used by the driller for sending the core barrel head assembly down the borehole 101. In response to the MD 104 engaging with the bottom of the drill string 146, the wireline and overshot 119 is detached from the spearpoint of the MD 104 and pulled back to the surface by the winch 118.

Completion of the deployment process results in the MD 104 being coupled to the drill string 146 via an engagement with the most distal drill rod 146a of the interconnected drill rod chain. In some embodiments, the coupling of the MD 104 to the drill string 146 involves a portion of the MD 104 extending out beyond the end of the drill string 146 (i.e., rod 146a). This extended portion of the MD 104 may correspond, for example, to all or part of a geological sensing component configured to obtain geological measurements from the strata and/or formation of the borehole or surrounding the borehole 101.

The extension of the component through the drill string 146 is advantageous in that it enables geological measurements to be obtained from the corresponding sensing component without interference with the material of the drill string 146. An example is a magnetic susceptibility component or sensor (as described below), which is configured to send out an electrical signal into the strata formation and is therefore vulnerable to taking readings of the drill string material rather than the strata and/or formation surrounding the borehole.

An initialization operation is performed to initialize the components of the MD 104 to prepare the device to perform a measurement of the borehole 101. In some embodiments, the initialization operation may include an initial alignment step where the attitude of the sensors of inertial sensing component 126 with respect to an Earth fixed reference frame defined by true North (the spin vector of the Earth) and gravity is estimated. During the initial alignment step, sensor errors, such as, for example, bias, scale factor or misalignment angles of the accelerometers 128 or gyroscopes 129 may be estimated in order to improve the accuracy of the estimated attitude of the sensors.

The skilled addressee will recognize that the alignment may be accomplished in many ways and that the method employed may be dependent on the particular sensor technology used (e.g. mechanical spinning mass gyros, FOGs, MEMs or ring laser gyros) and the specific way in which the sensors are mounted or mechanized (e.g. strap-down or mounted on a stable platform with one or more degrees of freedom) within the system. Non-limiting examples include a transfer alignment (i.e. manually setting the attitude to the known attitude of the drill string or borehole) or self-alignment operation by, for example, performing a coarse alignment followed by a fine alignment (e.g. utilizing a Kalman Filter, Extended Kalman Filter, Unscented Kalman Filter, divided difference filter, or second order central difference filter) according to methods known in the art for strap-down systems, or performing a gyro-compass operation for systems in which the sensors are mounted on a rotatable platform.

Initialization may be performed following deployment (i.e., in response to the removal of wireline 119 once the MD 104 is engaged at the base of the drill string 146), or just prior to deployment (i.e., at the top of the hole before the MD 104 passes beneath the surface). In the described embodiments, initialization includes the determination of values for the attitude of the sensors with respect to the earth's spin vector and gravity. The initialized sensor attitudes are utilized in the depth correction techniques performed by the MD 104, such as for example to enable compensation for, or removal of, effects due to the rotation rate of the earth and the acceleration due to gravity in the gyroscopes and accelerometers respectively. The remaining error in each sensor output (due to error in the attitude and residual and unmodeled sensor error) can be estimated while the MD 104 is stationary by comparing the sensor outputs to the expected output due to earth's rotation and gravity, as described herein below.

MD 104 is configured to generate one or more measurements of the borehole 101 during a measurement process performed after initialization and deployment of the MD 104. In the described embodiments, the measurements include at least a series of depth values indicating a corresponding depth of the MD 104 within the borehole 101. In some embodiments, the measurements also include values of geological data of the borehole 101 in the vicinity of the MD 104. Depth values and geological values are recorded by the MD 104 as a function of time. That is, the MD 104 is configured to continuously generate depth (and optionally geological) measurement data samples, and to record corresponding time values for the sample measurements, as the MD 104 navigates through the borehole 101 during the measurement process (as described herein below).

In some embodiments, the MD 104 is configured for depth measurement alone (e.g., where geological parameter data is not generated during the measurement process). The generation of geological parameter measurements may be toggled during initialization (i.e., to enable or disable the operation of one or more geological sensing modules). Irrespective of whether the MD 104 is configured to produce geological parameter measurements, the corrected depth values generated by the MD 104 provide a corresponding correction against errors associated with the movement of the MD 104 within the borehole 101.

In the described embodiments, the corrected depth measurements are produced based on the correction of inertial data (i.e., including at least accelerometer readings) obtained by the MD 104 during successive movement periods of the MD 104 within the borehole 101, as described herein below. In some embodiments, the correction of inertial data, and the generation of corresponding corrected depth values, is performed in real-time. In other embodiments, depth value correction is performed as a post-processing step executed by the controller after the MD 104 is removed from the borehole 101.

FIGS. 2b and 2d illustrate exemplary configurations of the measurement device 104 according to the described embodiments. In particular, FIG. 2b shows the general components of the MD 104 including: a deployment connector 133 enabling the device to be lowered into the borehole 101 via a wireline; one or more centralizers 134 to stabilize the device within the drill string 146; an engagement member 137 to hold the device in place in the string 146 on the completion of the deployment of the MD into the drill string; a sensing component 126 comprising inertial sensors including at least a plurality of accelerometers 128, possibly a plurality of gyroscopes 129 and a set of geological sensors 132 (e.g., for geological surveying) that can form part of the sensing component 126 or are separate therefrom; and a housing 139 that encapsulates the components.

As depicted in FIG. 2b, the drill string engagement member 137 is located towards the lower most end of the MD 104, so that the MD 104 is retained at the end of the drill string 146. However, a set of geological sensors 132 may be positioned at the lower most end of the MD 104 (i.e., beyond the engagement member 137) to enable the geological sensor 132 to extend beyond the corresponding engagement end of the drill string 146 such that the drill string 146 does not interfere with the operation of the geological sensor. An example of such a geological sensor that is located at the end of the drill string, can include a sensor that measures the mineralogy of the strata surrounding the bore hole, such as a Magnetic Susceptibility and/or conductivity sensor, that if located inside the drill string then the drill string would interfere with the tool. An example of a geological sensor, that can be located within the drill string, can for example, include a gamma tool.

FIG. 2d shows a schematic representation of one particular implementation of the components shown in FIG. 2b, where the MD 104 includes: a depthing module 130; a geological sensing module 132; one or more centralizers 134; a spear point 133; latch assembly 135; and a bitstop 137 that can engage with a bit that may be located at the end of the drill string. Components of the measurement device 104 are arranged in interconnected sections enabling the modular attachment and detachment of the components in accordance with a desired function of the MD 104.

Spear point module 133 provides a coupling for the attachment of the wireline 119 provided with an overshot to the MD 104. Latch assembly 135 provides a coupling for the releasable attachment of MD 104 to the drill string 146. Centralizers 134a, 134b bound an inner section containing the depthing 130 and geological sensing units 132a, 132b modules, which are powered by one or more batteries 131a, 131b. The centralizers maintain the MD 104 in a central position relative to the core barrel innertube if used and/or the drill rod 146a, such that the MD 104 is firmly within the drill string 146, such that on the occurrence of any lateral movement (e.g., shaking of the string) during the string extraction process the MD is held firmly in place. Bitstop 137 provides an abutment of the MD 104 against the drill bit 148 for the coupling of the MD 104 to the drill string 146.

During the drill string extraction process the drill string 146 and therefore MD 104 will experience axial accelerations which may be oscillatory in nature due to the drill string 146 operating as a distributed spring mass system. If the coupling of the MD 104 to the drill string 146 allows for undamped axial movement of the MD 104 with respect to the drill string 146 this may result in shocks to the MD 104. In one example, the latching assembly 135 includes one or more latching components (not shown) that are collectively configured to enable the MD 104 to be lowered down on a wireline 119 until the MD 104 is coupled with the drill string 146. For example, some conventional latching mechanisms commonly used include spring loaded latch dogs that extend radially into an annular latch seat formed on the ID of an outer tube (i.e. a member of the drill string or an outer core barrel depending on the particular system employed), such as, for example, as described in U.S. Pat. No. 2,829,868 or U.S. Pat. No. 5,934,393.

Shocks may be imparted to the MD 104 when axial movement of the MD 104 relative to the drill string 146 results in contact of the latch dogs with a shoulder of the latch seat resulting in a sudden deceleration of the MD 104 which may contribute to an increase in the occurrence of transient sensor errors. In some embodiments, latch assembly 135, bitstop 137, and centralizers 134a and 134b, operate to hold MD 104 within drill string 146, such that on the occurrence of axial movement during the extraction process the MD 104 is held firmly in place, or, at least, the axial travel of the MD 104 is reduced or the associated axial motion damped or slowed. In some such embodiments, latch assembly 135 is of the type that incorporates balls or rollers as the latching element that engage with the latch seat, such as, for example and without limitation, those described in U.S. Pat. No. 7,314,101 or U.S. Pat. No. 11,268,340. In such embodiments, the latch assembly 105 may reduce or substantially eliminate axial travel of MD 104 or provide damping to the axial movement of MD 104 thereby reducing the magnitude of axial shock and vibration which may reduce the occurrence of transient sensor errors.

The components of the MD 104 may be housed within a housing 139 composed of a resilient material, such as a metal or hard plastic, to provide protection to the internal modules during movements of the MD 104 within the borehole 101 (e.g., as the MD 104 is lowered into the hole 101 during the deployment process and as it navigates the borehole 101 during the drill string extraction process).

Geological sensing module 132 includes one or more sub-modules 132a, 132b collectively configured to generate data representing one or more geological data measurements of the borehole 101, and/or the formation/strata surrounding the borehole 101, during the measurement process. Exemplary embodiments of the geological sensing module 132 may include, for example, a total gamma system 132a configured to detect gamma radiation through the scintillation of light produced by the interaction of the gamma rays with a scintillator crystal material.

The MD 104 may also include a magnetic susceptibility and/or conductivity system 132b, including at least one receiver coil responsive to at least one transmitter coil to obtain at least one of magnetic susceptibility measurements and conductivity measurements from a region surrounding the MD 104. In some embodiments, the magnetic susceptibility and/or conductivity system 132b is located in the inner section of the MD 104. In other embodiments, the MD 104 is configured to extend beyond the end of the drill string 146. This is advantageous both to enforce a physical separation between the other system sub-component 132a and the magnetic susceptibility/conductivity system 132b (e.g., to minimize interference between the elements of the respective systems), and to prevent measurement of the drill string 146 material rather than the borehole strata (as discussed above).

Depthing module 130 is configured to generate measured depth values representing the path length between the collar position A (the entrance to the borehole 101 on the surface 110) and the present position of the MD 104 within the borehole 101, as a function of time.

FIG. 2c illustrates a schematic representation of the depthing module 130, including an inertial sensing component 126 and a controller 120. The sensing component 126 is configured to generate inertial data as the MD 104 moves through the borehole 101. In the described embodiments, the sensing component comprises, at least, a plurality of accelerometers 128 (e.g., three linear accelerometers) configured to generate accelerometer data representing acceleration values of the MD 104 over time.

In some embodiments, the sensing component 126 also comprises a plurality of gyroscopes 129 configured to generate gyroscope data as the MD 104 moves through the borehole 101. For example, the gyroscopes 129 may be rate gyroscopes configured to generate data representing the angular velocity of the MD 104 to enable determination of the attitude and heading of the accelerometers 128 in a chosen navigation reference coordinate frame. The raw measurement data generated by the sensing component 126, including the accelerometer data and optionally the gyroscope data, is referred to as “inertial data” in some embodiments.

In some embodiments the accelerometers 128 and gyroscopes 129 of sensing component 126 are configured as a strap-down system. In other embodiments, the accelerometers 128 and gyroscopes 129 are attached to a sensor platform connected to the chassis or housing of MD 104 by one or more gimbals. In such an embodiment, the gimbal may be stabilized with respect to gravity such that the roll or gravity toolface of the sensor platform is held constant with respect to gravity which may reduce the effects of some sensor errors such as, for example, residual sensor misalignments (e.g. remaining error in alignment of the sensitive axis of the sensor after calibration has been applied) by reducing or eliminating fluctuations in the component of gravity in the sensor output due to rotation of the MD 104 during the rod extraction process.

The sensing component 126 generates inertial data as a set of discrete measurement values obtained at corresponding sample time instants over the duration of a measurement process. The sensing component 126 is configured to obtain measurements from accelerometers 128, and optionally gyroscopes 129, and to generate corresponding inertial data values periodically according to a constant sampling period T=Δt. Depending on the sampling period, zero, one or more sample measurements may be generated during an arbitrary contiguous sub time interval of the measurement process (i.e., within either a movement or stationary time period).

The sensing component 126 transmits the determined inertial data to the controller 120. The controller 120 is configured to receive inertial data, including at least accelerometer data, from the sensing component 126, to correct the accelerometer data values, and to generate corrected depth measurements of the MD 104 according to the processes described herein.

The controller 120 includes a non-volatile memory 125 configured to store data and instructions for one or more operational modules of the depthing module 130, including at least the sensor component 126 and a communications interface 122. The controller 120 further includes a processor 123 configured to process data received from the sensing component 126 and the operational modules 121-125, and to process the data to cause the MD 104 to perform the depth measurement operations described herein.

The controller 120 includes a depth error correction module (DEC) 121 configured to process inertial data, including accelerometer data, received from the sensing component 126. The inertial data is received from the sensing component 126 via the I/O module 124 of the controller 120. The I/O module 124 passes the inertial data to the DEC 121 as a stream of real-time generated data samples. In the described embodiments, the DEC 121 is configured to: correct the accelerometer data generated by the sensing component; and generate, based on the corrected accelerometer data, corrected depth measurement values of the borehole in which the MD 104 is disposed within (as described herein below).

In some embodiments, the depthing module 130 is configured as an embedded system with the processor (CPU) 123 and memory 125 implemented as an integrated microcontroller with a RISC architecture, and the sensing component 126 configured as a peripheral device providing data to, and receiving control data from, the microcontroller. In other embodiments, the CPU 123 is a microprocessor chip having an architecture consisting of a single or multiple processing cores such as, for example, a 32- or 64-bit Intel architecture, and configured to exchange data with the memory 125, I/O module 124 and other components via one or more external buses.

In some embodiments, the depthing module 130 includes one or more data storage modules including one or more data structures configured to store data including one or more of: the depth measurement data generated by the DEC 121; and the inertial data, including accelerometer data, generated by the sensing component 126. In some embodiments, the data structures are also configured to store other data generated and/or processed by the depthing module 130.

In some embodiments, the MD 104 is configured to communicate with an external computing system 112 via the communications interface 122 (for example, to transmit the inertial data generated by the sensing component 126 to external system 112 having a configuration to perform depth error correction functions, such as those of the DEC 121, as described below). The communications interface 122 may include a modem or transceiver configured to perform a data transfer between the devices 104, 112 over a wireless or wired transmission media. In some embodiments, the external computing system 112 operates as a data processing device, such that the MD 104 and the external system 112 are configured to exchange data to collectively form a measurement apparatus 102.

In one embodiment a wired connection is established between the controller 120 of the MD 104 and the external computing system 112, such as via an Ethernet cable. For example, where the external computing system 112 is located on the deployment vehicle 106 (as shown in FIG. 2a), the cable may be housed within a cable enclosure and passed through the deployment mechanism 109 (not shown). In other embodiments, the communications module 122 may implement the IEEE 802.xx family of networking protocols enabling the exchange of information wirelessly with the external computing system 112 (e.g., over technologies such as WiFi).

The external computing system 112 may be implemented as a standalone computing device, such as a mobile device or computing workstation, comprising a central system bus, a memory system, a processor, a communications component, and I/O device interfaces. The processor may be any microprocessor which performs the execution of sequences of machine instructions, and may have architectures consisting of a single or multiple processing cores such as, for example, a system having a 32- or 64-bit Advanced RISC Machine (ARM) architecture (e.g., ARMvx). The processor issues control signals to other device components via the system bus, and has direct access to at least some form of the memory system, including one or more of: random access memory (RAM), non-volatile memory (such as ROM or EPROM), cache memory and registers, and high volume storage subsystems (e.g., HDDs or SSDs).

The external system 112 may include a communications component, such as a modem or transceiver device, configured to enable the establishment of a logical connection between the system 112 and other computing devices through a wireless or wired transmission media. The communications component is configured to enable system 112 to receive inertial data and/or data representing one or more corrected depth measurement values generated by the measurement device 104, via a data transfer with the communications interface 122 of the measurement device 104.

In some embodiments, the external system 112 implements one or more service modules including a structured query language (SQL) support module (e.g., MySQL) enabling data to be stored in, and retrieved from, a data store (such as an SQL database) configured to store any arbitrary type of data associated with the borehole 101 including borehole depth measurement data. The borehole depth measurement data may include one or more corrected depth values, as generated by the depth correction module 121 of MD 104, or by the analogous depth correction module of the system 112.

The external computing system 112 is configured to execute programming instructions of one or more software modules stored on non-volatile storage of the memory system. In some embodiments, the processes may be executed by one or more dedicated hardware components, such as field programmable gate arrays (FPGAs) and/or application-specific integrated circuits (ASICs).

The one or more software modules executed by the external system 112 includes a depth measurement application (DMA) configured to transmit data to, and receive data from, the MD 104. In the described embodiments, the DMA enables an operator to configure and initialize the MD 104 to perform the depth measurement process, for example by specifying one or more configuration parameters for the depthing 130. In some embodiments, the DMA provides a user interface which allows the operator to manually identify and differentiate intermediate stationary periods from rod removal (detachment) periods which may be logged to. In some embodiments, a record of the occurrence of the intermediate stationary periods with respect to time is generated and is subsequently used to correct depth measurements generated by the MD 104.

In some embodiments, the DMA is operable to generate corrected depth measurements for the borehole 101 analogously to the DEC module 121 of the MD 104, as described herein. In such embodiments, the external system 112 is configurable to receive logged accelerometer data from the MD 104, as obtained during measurement of borehole 101, and subsequently produce corrected depth measurements as an off-device post-processing operation on the logged data. The external computing system 112 may also include one or more general application programs providing methods, data structures or other software services that define data or perform functions as required by the system 112 (e.g., an operating system 216) to facilitate the generation of corrected depth values.

The skilled person in the art will appreciate that many other embodiments may exist of the MD 104 and/or external computing system 112, including variations in the hardware configurations, and the distribution of program data and instructions to execute the depth measurement methods described herein.

### Correcting Inertial Data for Depth Measurement

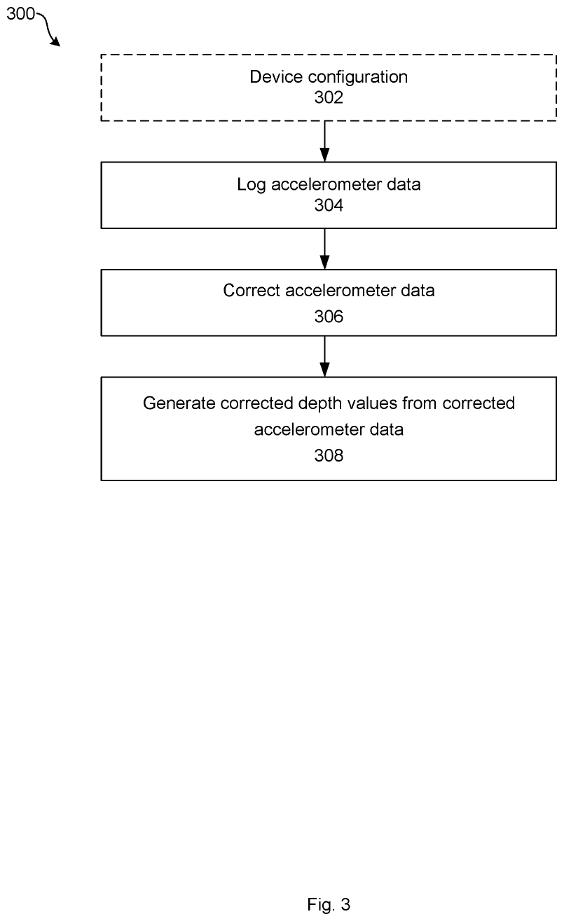

FIG. 3 illustrates a flow diagram of a method 300 for measuring the depth of a borehole 101 utilizing the MD 104 as part of the borehole drilling workflow. Method 300 is an example of a technique for utilizing the extraction of the drill string 146 from the borehole 101 to generate corrected depth measurements, via the correction of corresponding accelerometer data. In some examples, the corrected depth measurements may be subsequently correlated with corresponding measurements of the borehole 101 obtained via the MD 104 (such as geological measurements).

At step 302, prior to commencing the depth measurement, a device configuration process is performed to configure the MD 104 for conducting depth measurements for the borehole 101. In the described embodiments, device configuration involves: i) component set-up; and ii) device deployment.

During set-up, the functionality of the MD 104 is preconfigured for conducting depth measurements of borehole 101. In some embodiments, physical components of the MD 104 are selectively modified, such as for example to replace, add or remove particular sub-components of the geo-sensing module 132 in accordance with any geological surveying operations that are to be performed simultaneously with the depth measurement operations described below. Based on the physical configuration of the MD 104, the MD 104 is initialized to perform depth measurement and/or geological surveying operations.

Component setup may include the driller operating the DMA of the external system 112 to execute one or more device configuration routines of the MD 104. For example, the driller may operate the interactive user interface elements of the DMA to select one or more parameters for the depth measurement, and/or for any geological surveying activities to be optionally performed.

External device 112 transmits configuration data to the MD 104, via communications interface 122, such as for example by the transmission of a depth logging configuration message. In other embodiments, the operation of MD 104 may be pre-configured such that no further configuration of the MD 104 is required prior to the deployment of the MD 104 into the borehole 101.

Following the component set-up, the MD 104 is deployed into the borehole 101. Deployment is performed as described above with reference to FIG. 2a. Successful deployment of the MD 104 into the borehole 101 results in the coupling of the MD 104 to the bottom of drill string 146, via an attachment of the MD 104 to the most distal drill rod of the plurality of interconnected drill rods comprising the drill string 146.

At step 304, following deployment into the borehole 101, the MD 104 generates inertial data, including at least accelerometer data. In some embodiments, the generation of the accelerometer data is in accordance with one or more configuration operations performed by the driller during device configuration (i.e., at step 302). In some embodiments, the one or more configuration operations performed prior to deployment of the MD 104 into the borehole 101, cause the modules of the MD 104 to perform corresponding initialization functions after the deployment. For example, the MD 104 may be configured to detect the completion of the deployment process and to subsequently reset and/or commence data measurement operations.

In the described embodiments, sensing component 126 generates inertial data, including at least accelerometer data, by constantly producing sample measurements over time from initialization until the termination of the depth measurement process. In the described embodiments, the depth measurement process, including the generation of accelerometer data, the repeated correction of the accelerometer data, and the generation of corrected depth measurement values (i.e., steps 304 to 308), are integrated with the extraction of drill string 146 from the borehole 101, during which the MD 104 moves substantially linearly from an initial position near A′ to collar position A along axis X of the borehole 101.

Specifically, the MD 104 is configured to correct the generated accelerometer data by, repeatedly for each of a plurality of movement periods in which the MD moves within the borehole 101, altering the accelerometer data generated during corresponding movement periods of the MD 104. The alteration of the data reduces errors associated with the movement of the MD 104 through the borehole 101, based on the accelerometer data generated in at least one of a first stationary period of the MD 104 and a second stationary period of the MD 104 (i.e., periods of time in which the MD 104 does not move), where the first and second stationary periods occur respectively before and after the movement period. As the depth measurement process is bound to the drill string extraction process, the movement periods correspond to the extraction of a portion of the drill string 146 from the borehole 101. The resulting corrected depths can be correlated to the geological sensor data collected during the corresponding movement period to provide improved accuracy.

### Drill String Extraction

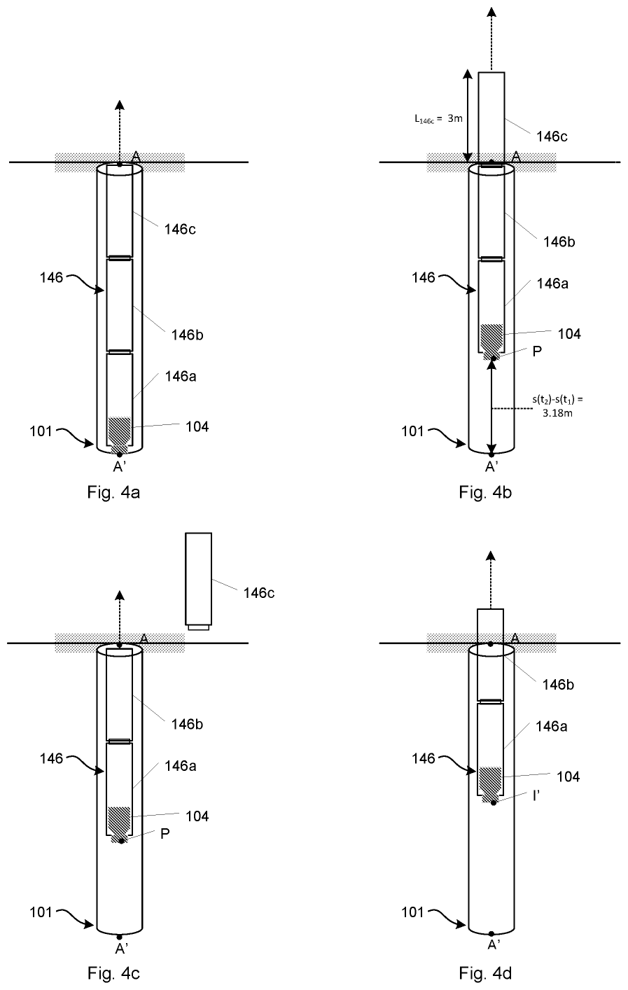

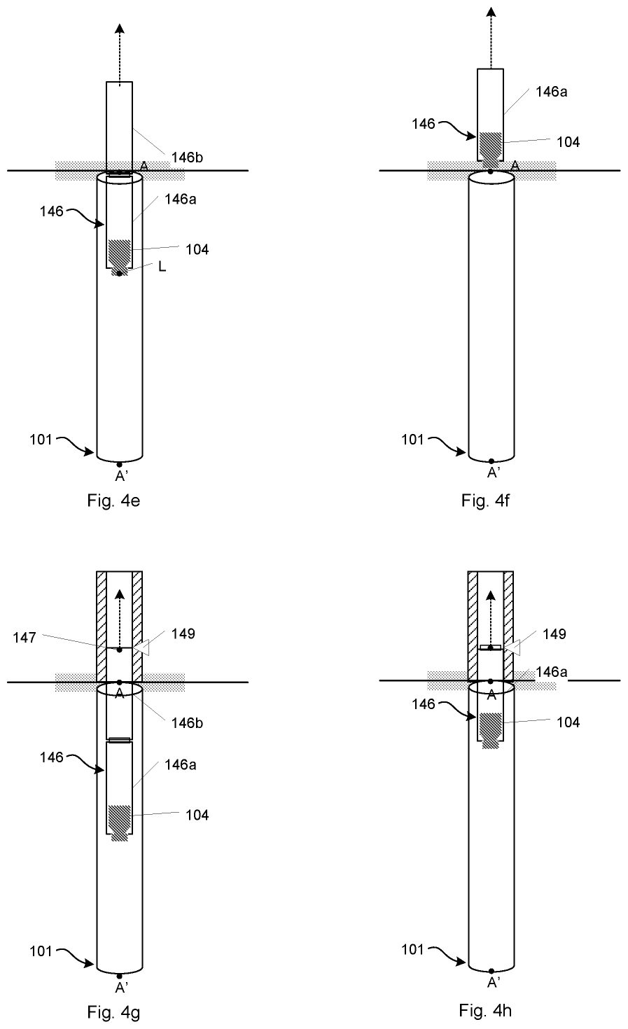

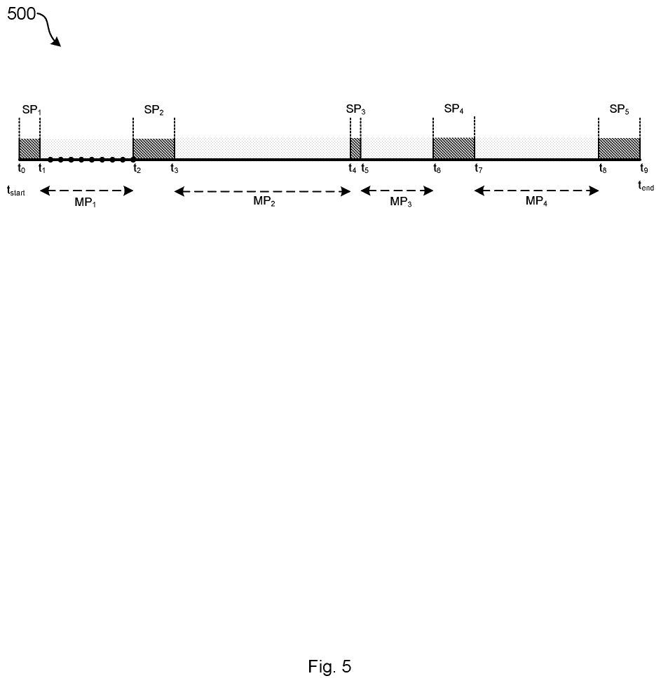

FIGS. 4a-f and FIG. 5 are schematic diagrams and a timing diagram respectively which illustrate the movement of the MD 104 during the drill string extraction process. FIG. 4a shows the MD 104 at the commencement of the depth measurement process 300. The MD 104 is located at position A′ at the bottom of borehole 101 and is coupled to drill rod 146a located at the distal end of drill string 146. Drill string 146 is comprised of three interconnected drill rods 146a, 146b and 146c. An extraction means, such as a cable, or a drill rod handler on a drill rig is tethered to the drill string 146 at the proximal end of drill rod 146c, located at or around position A at the hole collar.

Drill string extraction involves the operation of the extraction means to exert a pulling force on the drill string 146, causing the removal of a portion of the drill string 146 from the borehole 101 (i.e., the removed portion being that which exits the borehole 101 in response to the pulling force). The MD 104 experiences movement as a result of various driller initiated commands during the drill string extraction process, where the movement may be continuous, interrupted, reversed, and/or momentarily stationary in any combination or order. The removal and detachment of drill rods of the drill string 146 proceeds repeatedly until the final drill rod, as represented by 146a in FIGS. 4a-4f, has been extracted (as described below).

FIG. 4b shows the extraction of a portion of the drill string 146 corresponding to drill rod 146c. MD 104 moves from position A′ to position P causing the section of drill string 146 corresponding to rod 146c to exit the borehole 101 above the surface 110. That is, the MD 104 experiences a substantially linear movement between positions A′ and P as occurring over a first movement period MP₁. As shown in FIG. 5, the movement period MP₁ occurs in the time interval (t₁, t₂). Associated with MP₁ are first and second stationary time periods SP₁=[t₀, t₁] and SP₂=[t₂, t₃] in which the MD 104 is stationary within the borehole 101. First stationary time period SP₁ corresponds to the time during which the MD 104 is idle following initialization and prior to the commencement of the drill string extraction.

Once the portion of the drill string 146 corresponding to drill rod 146c is removed from the hole 101, the extraction is halted. As shown in FIG. 4c, the MD 104 remains stationary at position P while drill rod 146c is detached from the drill string 146. In the described embodiments, the drill rods 146a-c of string 146 are interconnected by threads. Detachment of the rod 146c from the drill string 146 involves unthreading the interconnection of the drill rod 146c to the adjacent interconnected rod 146b. Second stationary time period SP₂ corresponds to the time during which the MD 104 is idle during the detachment of the drill rod 146c.

Once rod 146c is detached, the extraction commences with drill string 146 now comprising rods 146b and 146a. MD 104 experiences a period of substantially linear motion between position P and intermediate position I′ at which the portion of the drill string removed from the hole 101 is a part of rod 146b (as shown in FIG. 4d). The drill string extraction may be halted with the MD 104 at position I′ due to the occurrence of an unplanned or undesired event during the drilling workflow. For example, the drill string 146 may have become stuck, or a mechanical failure of the drill string extraction apparatus (e.g., the drilling rig 141) may have occurred, resulting in the drill string 146 remaining stationary or undergoing rapid back and forth motion as the driller attempts to break the string free. The corresponding stationary period SP₃=[t₄, t₅] is shown in the timing sequence of FIG. 5.

On the commencement of the extraction process, the MD 104 is moved from I′ to position L enabling the extraction of the remaining portion of rod 146b from the hole 101 (as shown in FIG. 4e). In some embodiments, the MD 104 detects stationary period SP₃, despite its shorter duration compared to periods SP₁, SP₂, SP₄, and defines two movement periods MP₂=(t₃, t₄) and MP₃=(t₅, t₆) for the motion from position P to L. In other embodiments, the MD 104 is configured to ignore, or otherwise does not detect, stationary period SP₃ such that movement period MP₂ extends from t₃ to t₆ (i.e., MP₂=(t₃, t₆)). In some embodiments, the operator identifies through the DMA that SP₃ should be ignored. The DMA is operable to send a directive or command to the MD 104 to program the depthing module 130 to automatically ignore candidate stationary periods according to one or more operator-configurable recognition parameters. The recognition parameters may include, for example, a duration of the candidate stationary period, and/or a maximum frequency of stationary period detection.

The MD 104 remains stationary within borehole 101 at position L for a stationary period SP₄=[t₆, t₇]. Then, after the detachment and removal of rod 146b from drill string 146, the extraction process continues and MD 104 is moved, in movement period MP₄=(t₇, t₈) depicted in FIG. 5, from position L to position A at the collar of the borehole 101. This corresponds to the extraction of the drill rod 146a, and the MD 104 from the hole 101 (as shown in FIG. 4f). The MD 104 remains stationary during stationary time period SP₅[t₈, t₉] as the MD 104 is detached from the drill rod 146a, upon which the measurement process is complete.

FIGS. 4a-4f illustrate a typical drill string extraction process in which the drill rods are each removed and detached from the string individually and sequentially throughout the extraction. In some instances multiple drill rods are removed from the borehole between successive detachment operations (i.e., in a single pull of the drill string). For example, each movement period may involve the extraction of a length of the drill string 146 from the borehole 101, where the extracted portion is comprised of multiple interconnected drill rods (e.g., two or more of rods 146a-146c). The techniques and methods described herein are equally applicable in these instances by treating the effective extracted portion of the drill string (e.g., the portion formed by two or more of interconnected rods 146a-146c) as a single ‘drill rod’ on which the relevant calculations are based.

Returning to FIG. 3, the depthing module of the MD 104 is configured to generate corrected depth measurements continuously over time, simultaneously with the continuous generation of accelerometer data (i.e., at step 304), as the MD 104 traverses the borehole 101 according to the drill string extraction process illustrated in the examples of FIGS. 4a to 4f and 5. The depther module 130 corrects the generated accelerometer data incrementally in accordance with successive movement periods of the MD 104. Depth error correction module 121 is configured to process the stream of accelerometer data generated by the sensing component 126 and to determine corresponding movement periods MP during which the MD 104 experiences motion within the borehole 101.

In the described embodiments, depth error correction module 121 detects whether corresponding stationary periods of the MD 104 occur in response to the detachment of a rod and those periods occurring in response to an intermittent disruption of the drill string extraction. The sensing component 126 continuously generates accelerometer data while the MD 104 remains within the borehole 101. Consequently, in the described embodiments the depth error correction module 121 is configured to identify the corresponding accelerometer data samples as from a movement of the MD 104, from an intermediate stationary period of the MD 104, or from a detachment stationary period, of the MD 104.

In the described embodiments, the correction of accelerometer data is performed for the accelerometer data sampled at time instances irrespective of whether the MD 104 was moving or not at the time of data generation. That is, one or more “fixed” compensations, such as factory calibration, sensor error updates from initial alignment and the sensor nulls (aka bias updates), are determined successively at each stationary period

In some embodiments, error correction or compensation techniques are applied to accelerometer data generated within a movement period, where the error correction or compensation is based at least in part on data determined during one or more of the stationary periods that bound the movement period. That is, each movement period MP is bound by first and second stationary periods corresponding to the detachment of a drill rod from the drill string 146 (e.g., MP=(t₃, t₆) as shown in FIG. 5) and may therefore have error correction applied.

### Correcting the Accelerometer Data

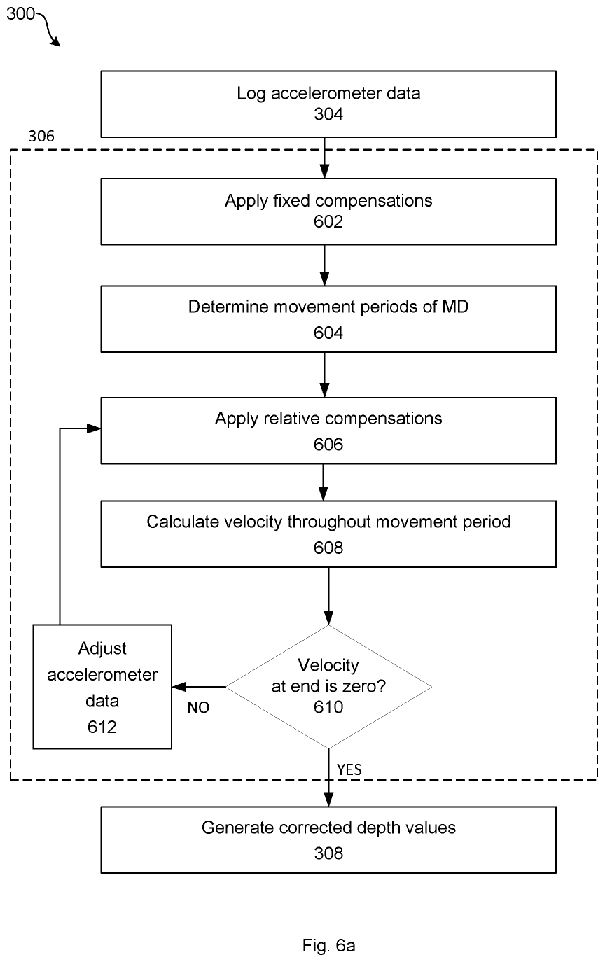

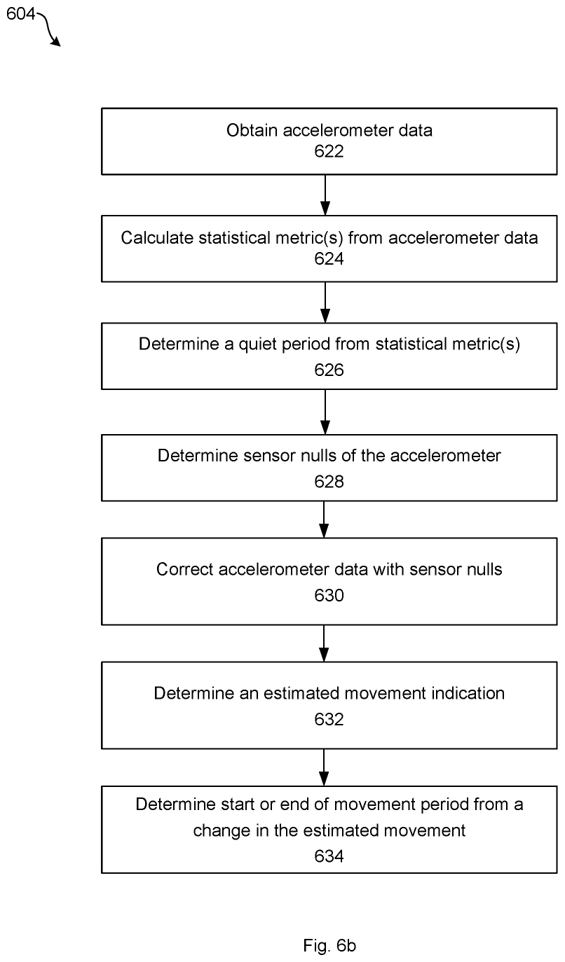

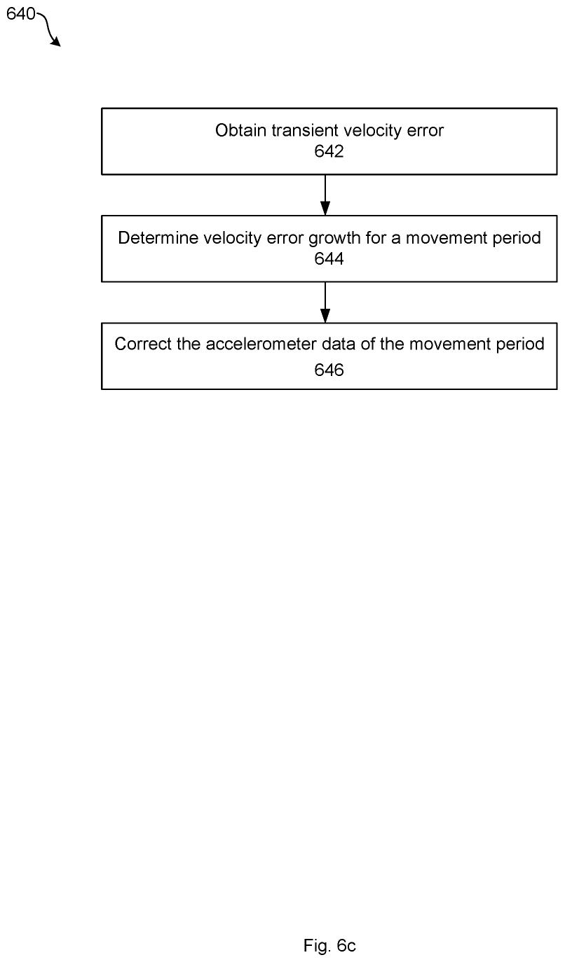

At step 306, the controller 120 is configured to correct the generated accelerometer data to reduce errors associated with the movement of the MD 104 within the borehole 101. Sensing component 126 provides the generated accelerometer data to the controller 120 via I/O module 124. FIG. 6a illustrates the accelerometer data error correction sub-process performed by the DEC 121 according to the described embodiments.

### Fixed Compensations

At step 602, the DEC 121 applies one or more fixed compensations to the accelerometer data and gyroscope data. In some embodiments, fixed compensation of the accelerometer and gyroscope data involves adjusting the values of the accelerometer and gyroscope data to compensate against artefacts or biasing effects in the respective components.

In some embodiments, fixed compensations may be performed on the accelerometer and gyroscope data as factory calibration, filtering or pre-processing operation. More generally, fixed compensations refer to corrections to account for effects that are invariant to the specific characteristics of the motion of the MD 104, and may include for example: 1) Applying filtering to reduce the effects of noise; 2) Applying calibration coefficients, such as one or more biases, scale factors, and axis misalignment corrections with respect to temperature; 3) Applying corrections to one or more properties of a sensor as obtained during initial alignment; and 4) Compensate for the effects of the earth's rotation.

In the described embodiments, the DEC 121 is configured to correct the accelerometer data by applying at least one of the compensations (1)-(4) above. For example, at step 602 applying fixed compensation may involve applying calibration data obtained during the configuration and initialization of the MD 104. In some embodiments, the calibration data is stored in a non-volatile portion of a memory, or a data store, of the controller 120 at a time of manufacture of the depthing module 130. In other embodiments, the calibration data may be received from an external computing system. For example, the driller may invoke a measurement tool calibration routine on the DMA to cause the presently stored calibration data to be updated with data provided by the external system 112.

In some embodiments, the DEC 121 performs fixed compensations according to the sensor configuration of the depthing module 130. Fixed compensations for accelerometers include corrections to account for the earth's rotation, centrifugal and Coriolis effects. For gyroscopes, the DEC 121 may be configured to perform fixed compensations that account for the appropriate component of the earth's rotation rate (e.g., by subtracting this value, as calculated based on the attitude of the sensors with respect to the spin vector of the earth, from the measured sensor value). The DEC 121 is configured to receive the accelerometer data generated by the sensing component 126 during measurement of depths of the MD 104 within the borehole 101, and adjusts the data values in real-time.

### Determining a Movement Period

At step 604, the DEC 121 processes the accelerometer data to determine a movement period MP of the MD 104 within the borehole 101. As described above, movement period MP is a time interval in which the MD 104 experiences substantial movement and/or motion where the tool moves substantially parallel with and/or along the axis or centre line of or motion within the borehole 101 between consecutive first and second time intervals in which the MD 104 is stationary.

In the described embodiments, the DEC 121 is configured to determine movement period MP of the MD 104 by processing the output of one or more accelerometers to detect motion of the MD 104. In one exemplary implementation, the output of a given accelerometer over a time period is processed to determine “nulls” which correspond to periods of relatively low accelerometer output. For example, the nulls may be defined by accelerometer outputs that are, on average, low compared to an accelerometer output expected due to gravity. By correcting against the sensor nulls, the output of one or more accelerometers is utilized to detect stationary periods bounding the movement period MP (and therefore to detect the MP itself).

FIG. 6b illustrates a sub-process executed by the DEC 121 for determining the movement period MP by processing the output of one or more sensors in a sliding window. At step 622, the DEC 121 obtains output data from an inertial sensing component 126 of the MD 104. In the described embodiments, the DEC 121 module processes the output of at least one accelerometer 128 in a sliding window comprising a predetermined number of data samples. In other embodiments, the output data samples include data output by other sensors such as gyroscopes 129.

At step 624, the DEC 121 calculates one or more statistical metrics derived from a window of the accelerometer output data signal. In the described embodiments, a sliding window is formed over a predefined number of samples of the accelerometer data. The number of samples is configurable in accordance with a desired window size (e.g., 0.25 s to 10 s). The DEC 121 calculates a statistical metric indicating a variation in the output window values over time. For example, the DEC 121 may determine a standard deviation value of the accelerometer output of the accelerometer sensor. In some embodiments, the one or more statistical metrics are determined from the joint outputs of a plurality of accelerometers or other inertial sensing components. For example, the DEC 121 may calculate the vector acceleration from the magnitude of the outputs of 3 orthogonal accelerometers.

At step 626, the DEC 121 determines a quiet period of the output data by comparing the calculated one or more statistical metrics (e.g., a standard deviation of the output values) to one or more corresponding predetermined values (e.g., a movement threshold value). Quiet periods represent time intervals in which the output of the sensing component is considered, by the DEC 121, to be below a minimum value that would otherwise be expected to be generated by the component in response to movement of the MD 104. In some embodiments, the movement threshold value(s) are adjusted dynamically such that the threshold values used to determine a present quiet period are determined at least in part by the values of one or more statistical metrics calculated for at least one previously determined quiet period.

In the described embodiments, the DEC 121 is configured to determine one or more null estimate values of the accelerometer by processing the output values of the determined quiet period (i.e., as step 628). The DEC 121 calculates a representative value of the quiet period accelerometer output over a predetermined most recent number of quiet periods (e.g., a number of periods corresponding to the most recent 0.5 s to 20 s). In one example the quiet period values are averaged to obtain the null estimate values. These values, also referred to as “nulls” or “sensor nulls”, represent the sensor output inclusive of gravity and earth's rotation rate as well as all residual and unmodeled sensor errors. In some embodiments, the averaging involves a weighted averaging operation where the relative weights are determined by the computation of the standard deviation (or other statistic metric) of the sensor outputs during each quiet period used in the calculation (e.g., a lower standard deviation results in larger weight).

At step 630, the DEC 121 applies the null estimate value(s) to correct the accelerometer output data. In one example, correction is performed by removing the most recent estimates of the sensor nulls from the accelerometer output data. At step 632, the corrected output data is integrated to determine an indication of movement, which may be in the form of a velocity, displacement and/or attitude value (depending on the sensing component). For example, the DEC 121 generates the velocity or displacement values according to a single or double integration process, as described at step 308 below to determine corrected depth measurement values.

At step 634, the DEC 121 compares the estimated indication of movement of the MD 104 to one or more previously calculated indications to determine a relative change in the indication value over time. In response to a change in the indication of movement, the DEC 121 determines the occurrence of a start time or an end time of the movement period. In some embodiments, the DEC 121 compares a change in the velocity, displacement and/or attitude indication to a pre-determined threshold to identify when the MD 104 commences moving and therefore the start of a movement period. Conversely, the DEC 121 determines when the MD 104 stops moving and enters the next stationary period (e.g., in response to the change in indication value being below a threshold). In some embodiments, successive movement periods of the MD 104 are determined by repeating steps 622 to 632 with output data that is obtained continuously over time from one or more sensing components 126.

In some embodiments, the DEC 121 determines the sensor nulls contemporaneously with the application of fixed compensations (i.e., at step 602), when both activities are performed during one or more stationary periods. In other embodiments, the DEC 121 determines the sensor nulls dynamically prior to their use in the relative compensation process of step 606 (described below).

In the described embodiments, the DEC 121 is configured to detect intermediate periods in which, following the commencement of the drill string extraction process, the MD 104 is stationary (or experiences non-linear motion, for example during a side to side movement of the drill string performed in response to a stuck drill rod), and to ignore the intermediate periods in the determination of the movement period(s) for accelerometer data error correction.

In some embodiments, the DEC 121 is configured to check the displacement determined in the preceding movement period against a predetermined threshold to determine if the present stationary period is an intermediate period or a detachment period. A threshold below the smallest rod length (e.g., 2 m for rods of a minimum 3 m length) may be selected. Alternatively, the threshold may be adjusted based on a known rod length as entered during a configuration stage of the initialization process.

### Relative Compensations

With reference to FIG. 6a, the DEC 121 is configured to incrementally correct the accelerometer data for the determined movement period MP by performing a series of error compensation steps (i.e., steps 606-612) on the corresponding accelerometer data, including: i) determining relative error compensations to correct the inertial data (including at least accelerometer data); and ii) performing automatic velocity error compensation on the corrected inertial data. The DEC 121 applies the compensation steps iteratively such that the relatively compensated accelerometer data values determined for movement period MP are repeatedly adjusted based on the outcome of the velocity error compensation.

Let a(t) represent the accelerometer data vector generated by the sensing component 126, such that aᵢ(t) is the sampled acceleration value obtained from accelerometer i at a time t. In the described embodiments, the plurality of accelerometers 128 includes three orthogonally orientated sensors such that a(t) is a three-dimensional vector representing acceleration readings in the respective Cartesian x, y, and z directions of orientation. Let MP be the movement period over which the DEC 121 performs correction. MP is a time interval of motion of the MD 104 along the axis of the borehole 101, where MP has adjacent respective first and second stationary time periods SP₁ and SP₂ in which the MD 104 is at rest. Each interval of MP, SP₁ and SP₂ and the corresponding sets of accelerometer data vectors occur at unique times and are determined by the DEC 121 at step 304.

The skilled addressee will appreciate that the inertial data generated by the sensing component 126, such as accelerometer data and gyroscope data, consists of a set of discrete values defined at sample time instants at which corresponding measurements are obtained (i.e., readings of the accelerometers, gyroscopes, and other sensors). That is, although the accelerometer data, gyroscope data and other data may be denoted as continuous functions herein, the described embodiments of the DEC 121 perform the equivalent operations and/or transformations over the discrete set of sample values corresponding to measurement data generated by the sensing component 126.

Furthermore, as will be appreciated by the skilled addressee, in response to the integration of discrete sample outputs of the inertial sensing components (i.e., to obtain a change in attitude, velocity or displacement), errors may be introduced as a result of high frequency angular rate or accelerations near the integration period resulting in coning, sculling or scrolling errors respectively. Therefore, although the integration operations may be simply referred to as integration or discrete integration or summation, the described embodiments of the DEC 121 may perform coning, sculling or scrolling error compensations as part of the integration operations at a sample rate equivalent to or higher than the sampling rate used for the remaining steps described herein.

Additionally, the DEC 121 may be configured to represent attitude of the sensors with respect to the reference frame in a number of ways, such as, for example and without limitation: Euler angles; direction cosine matrices; or quaternions, which are updated by propagating the corrected sensor component output values at each sample instance through a navigation or attitude estimation and tracking algorithm. The navigation or attitude estimation and tracking algorithm estimates the change in attitude due to the output values in a manner appropriate to the selected representation and sensor mechanization (e.g. strap-down or stable platform with one or more degrees of freedom). Therefore, although the updating of the attitude of the sensors with respect to the reference frame may be referred to as simply integration or propagation, the DEC 121 is configurable to perform the update according to any other appropriate method.

In some embodiments, the DEC 121 is configured to process the accelerometer data values generated by the sensing component 126 to produce a scalar value a(t) representing the acceleration of the MD 104 in its path of motion along the axis of the borehole 101 during drill string extraction. For example, in some embodiments, the DEC 121 calculates the magnitude of the accelerometer data vector to produce the sampled acceleration value a(t)=∥a(t)∥ of the MD 104 at time t. In other embodiments, the DEC 121 is configured to use the output of a single accelerometer as the acceleration data a(t).

Although the scalar acceleration values are used to illustrate the error correction and depth measurement processes below, the skilled addressee will appreciate that in other embodiments the DEC 121 may be configured to perform the equivalent operations on the vector accelerometer data.

At step 606, the DEC 121 determines relative compensations to apply to the inertial data generated over the movement period MP. In some embodiments, the relative compensations include applying a sensor-specific correction to the values of each sensing component 126. For example, the DEC 121 may generate one or more null estimate value(s) (“sensor nulls”) for a given accelerometer and apply the sensor nulls to the sensor outputs as a form of relative compensation.

In some embodiments, the relative compensations include compensating for the value of the acceleration due to gravity (e.g., g) for particular sample times. The acceleration due to gravity (referred to as “gravity” values) are determined during the first and second stationary periods SP₁ and SP₂ associated with the movement period MP. To maximize the gravity accuracy and reject spurious noise induced errors, only the accelerometer values whose adjacent readings are stable are retained and averaged for use (the “stable accelerometer values”).

In some embodiments, the DEC 121 is configured to determine the stable accelerometer values by processing the accelerometer data in the stationary periods to calculate one or more statistical metrics (e.g., to indicate variation in the data values). An expected or representative value of stationary period accelerometer data is determined from the statistical metrics, similarly to the determination of the sensor nulls (i.e., in steps 622-628 described above).

The DEC 121 generates indications of the stable total gravity g^{sp1} and g^{sp2} from the stable accelerometer values of the first and second stationary periods. In some embodiments, the stable total gravity values are time averaged values from data obtained within the respective stationary period.

In some embodiments, the sensing component 126 is configured to generate gyroscope data from the plurality of gyroscopes 129. The gyroscope data may include, for each gyroscope: the angular velocity w, and attitude h. The sensing component 126 provides the generated gyroscope data to the controller 120 via I/O module 124. The combination of the accelerometer data and the gyroscope data forms inertial data. As some accelerometers are sensitive to the accelerations associated with movement of the MD 104, in some embodiments the DEC 121 is configured to process the gyroscope data instead of, or preferentially to, the accelerometer data to determine a change in attitude of the MD 104 during a movement period.

An exemplary process for performing gravity compensation using an indication of the stable total gravity g^{sp1} determined from the first stationary period SP₁ involves the following steps, as performed by the DEC 121: 1) determine, from the stable accelerometer values of the first stationary period, values of the dip (θ_{accel}^{SP1}) and gravity toolface (GTF^{sp1}); 2) Update the representation of attitude with respect to the earth fixed reference frame using θ_{accel}^{SP1} and GTF^{sp1}; 3) Find the sensor nulls, as described above, including for at least one accelerometer, a weighted average of stable acceleration values from the first stationary period; and 4) For each sample during the sub-sequent MP: 4a) Integrate the corrected data samples to determine change in attitude; 4b) Calculate a change in expected gravity sensed in the stable accelerometer values due to change in attitude over time; and 4c) Calculate null and gravity compensated accelerometer values by subtracting, from each accelerometer value, the weighted average of stable accelerometer values from the first stationary period (as calculated at step 3), and the change in expected gravity sensed in the stable accelerometer values due to change in attitude over time (as calculated at step 4b).

In some embodiments, the DEC 121 is configured to perform relative compensation to correct the gyroscope data of the inertial data. For example, relative compensations may be performed to correct the gyroscope data generated by a given gyroscope by determining one or more sensor nulls and applying the sensor nulls to the sensor outputs.

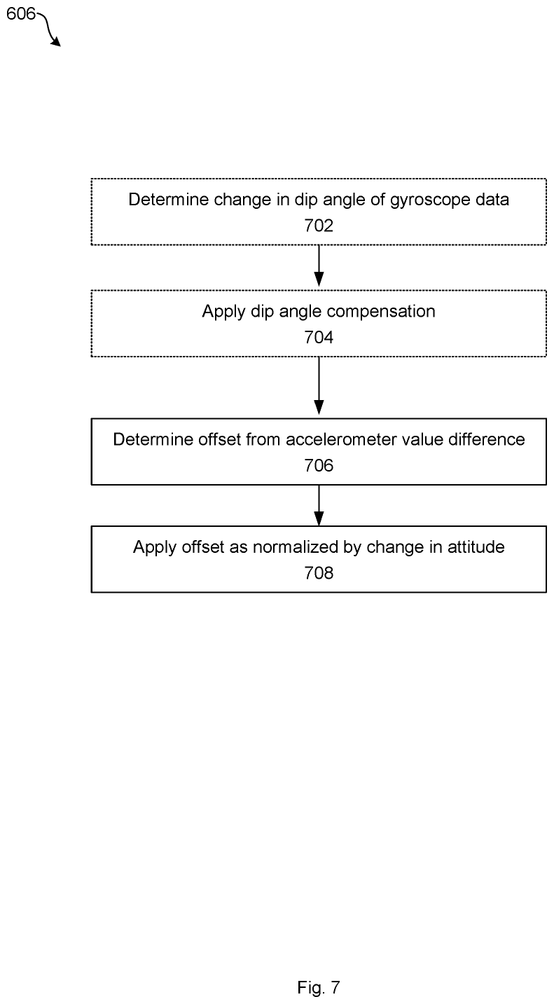

In another example illustrated by FIG. 7, the relative compensations include the DEC 121 optionally compensating for an accumulated error of the gyroscope data by consideration of the dip (pitch) angle θ. The DEC 121 resets the starting dip determined from the gyroscope data to a corresponding value determined from the stable accelerometer values a^{sp1}(t) of the first stationary period SP₁. The pitch angle θ is obtained by performing discrete time integration over the obtained gyroscope readings (i.e., the angular velocity values w).

At step 702, the DEC 121 optionally performs relative error compensation of the gyroscope data by determining a change in the dip (Δθ). The change in dip is obtained by comparing the propagated gyroscope dip to the corresponding accelerometer dip values immediately after the movement period MP (i.e. at the start of SP₂). Then, at step 704 the change in the dip (ΔDip) is applied ratiometrically to the dip values produced by the gyroscope data over the movement period (i.e., to correct for errors in the gyroscope data generated in MP). The resulting dip produced from gyroscope values generated at the end of the movement period MP (i.e., just prior to the second stationary period and SP₂) coincide with those from accelerometer values generated immediately after the movement period (i.e., during the second stationary period SP₂). In some embodiments, step 704 is performed only if the change in dip is greater than a predetermined threshold that is derived based on the expected accuracy of the accelerometer and gyroscope determined dip values.

The steps 702 and 704 compensate for an accumulated error due to a gyroscope bias (or “drift”) of one or more of the plurality of gyroscopes 129. This enables the generation of gyroscope measurements of improved accuracy, especially for larger movement periods (i.e., where the accumulated gyroscopic attitude error may become a significant source of measurement error).

Steps 702 and 704 are optional based on whether the sensing component 126 is configured to generate gyroscope data as part of the inertial data. The relative compensations also include applying corrections to the accelerometer data. At step 706, the accumulated error in the accelerometer data is compensated for based on the accelerometer values determined during the first and second stationary periods, inclusive of the MD attitude.

For example, in some embodiments the difference between the stable total gravity values in the first and second stationary periods is calculated to compute a total gravity offset g_{offset}=g^{sp2}−g^{sp1}. At step 708, the total gravity offset value is then normalized by the change in a determined attitude value (either from an accelerometer or gyroscope) at the current time instant, and the normalized offset is applied to values determined during motion (i.e., within the movement period MP), ratiometrically, to produce the relatively compensated values of the estimate of total gravity.

### Velocity Error Compensations

It is desirable to reduce the velocity error observed at the end of a movement period. The velocity error may have a component related to drift (i.e., from residual and unmodeled sensor errors) and gravity compensation errors. The application of one or more relative compensations to the accelerometer, and/or gyroscope, data may reduce or eliminate the drift and gravity compensation errors so as to minimize their effect on the velocity. In some embodiments, following performing relative compensations at step 606, further specific velocity error compensations are performed to address a velocity error that potentially remains after the effects of drift and gravity compensation errors are accounted for (referred to as a residual velocity error).

With reference to FIG. 6a, the DEC 121 is configured to perform velocity error compensation on the relatively compensated accelerometer data. The velocity error compensation involves generating adjusted accelerometer data to cause corresponding velocity data to indicate that the MD 104 is stationary at the end of the movement period MP.

In some embodiments the DEC 121 implements an iterative velocity error compensation process. At step 608, the DEC 121 determines, based on accelerometer data during the movement period ã(t), t∈MP, an indication of the velocity of the MD 104. The relatively compensated accelerometer data values are integrated with respect to time to produce corresponding velocity values v(t). In some embodiments, the DEC 121 performs the integration over the discrete time domain of the sample space, for example by using a recursive summation. In other embodiments, the DEC 121 is configured to extrapolate the discrete time sample values to a continuous function and to perform the integration based on the analytic function expression.

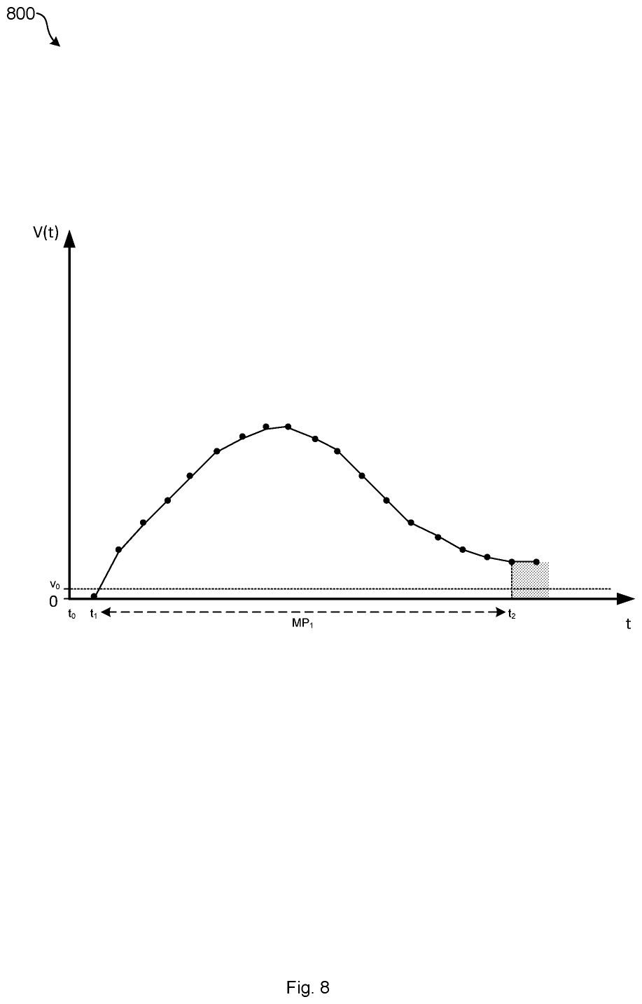

FIG. 8 shows an illustration of a graph 800 of an exemplary velocity function obtained from integrating the exemplary relatively compensated accelerometer values. In this example, movement period MP is defined over interval (t₁, t₂). As the MD 104 is stationary at t₁ and t₂ directly before and after the movement period (since stationary periods SP₁ and SP₂ end and start at these times respectively), a non-zero velocity at these times (i.e., |v(t₂)|>0) represents an error in the accelerometer data. The value of v(t₁) is set to zero as a part of the integration process.

The DEC 121 thereby detects and compensates for errors by: (a) determining, based on accelerometer data during the movement period ã(t), t∈MP=(t₁, t₂), a non-zero velocity of the MD 104 at, at least, the end of the movement period; (b) incrementally adjusting the accelerometer data to cause a corresponding adjustment of the velocity v(t) during, and at the end of, the movement period MP; and (c) checking the adjusted velocity of the MD 104 at the end of the movement period (v(t₂)), and iteratively repeating steps (a) and (b) until the adjusted value is zero.

For example, with reference to the velocity graph of FIG. 8, at step 610 the DEC 121 determines that there is a non-zero velocity of the MD 104 at the end of the movement period (i.e., that |v(t₂)|>0). For example, in some embodiments the adjustment function is applied to offset the acceleration values by a constant β(t) applied to the acceleration values in a given iteration based on the degree of error in the velocity value(s) determined at step 608. For example, the DEC 121 may be configured to incrementally reduce the value of v(t₂) to approach 0 during the iterative correction process.

In some embodiments, the DEC 121 is configured to check the velocity value at the end of the movement period MP against a threshold value v₀ instead of the value 0, such that a velocity value of v(t₂)<v₀ is considered to be “zero” by the DEC 121. This enables the iterative correction process to terminate in the event that it is not possible to correct the acceleration values to achieve a velocity of exactly 0 at t₂. The threshold value v₀ may be predetermined, user configurable (such as during initialization), or otherwise determined by the DEC 121.

In the described embodiments, after the acceleration values are adjusted in step 612, the DEC 121 repeats the relative and automatic velocity compensation steps with the newly adjusted acceleration values. The iterative repetition of steps 606-612 enables the correction of the measured accelerometer data to reduce errors associated with the movement of the MD 104 over period MP. In some embodiments, the DEC 121 may be configured to perform the acceleration correction without re-calculating the relative compensations in every iteration (e.g., relative compensation may be performed only for the first iteration in order to increase computational efficiency).

The DEC 121 performs velocity error compensation according to the above described process by treating the residual velocity error value as the result of a constant accelerometer value offset. In some implementations transient errors are present in the output of one or more of the sensors of sensing component 126. In such implementations, the residual velocity error is a result of non-constant components. To address this, in some embodiments the DEC 121 is configured to perform a second velocity compensation process either in addition, or as an alternative, to the velocity error compensation of steps 608 to 612.

FIG. 6c illustrates an implementation of the second velocity compensation process 640 (referred to as transient error compensation) performed by the DEC 121 to correct transient errors of one or more accelerometers. At step 642, the DEC 121 obtains an indication of the residual velocity error that is associated with transient errors and an indication of the residual velocity error that is associated with constant errors. In some implementations, the transient error component of the residual velocity error is determined by applying constant error velocity compensation (i.e., under the assumption that the remaining non-constant error is from the transient source).

The DEC 121 is configured to implement one or more techniques to determine a portion of the velocity error that is likely a result of, or can be accurately modelled by, a constant offset in the accelerometer values during the moving period. For example, the DEC 121 may be configured to compare the (fixed and/or relatively compensated) accelerometer outputs over the end stationary period to the expected value of acceleration due to gravity, and to determine a difference term to be used as the constant offset error. Alternatively, or in addition, the DEC 121 may be configured to estimate the slope of the velocity graph of the MD 104 over the end stationary period, and to use the slope value to derive the constant offset error. DEC 121 may then determine a transient velocity error, the portion of the residual velocity error due to transient error sources, by subtracting from the residual velocity error the portion attributed to a constant offset error in the accelerometer values where the offset is determined as described above.

At step 644, the DEC 121 determines a time-varying function of the velocity error growth during the movement period. The velocity error growth function provides a profile of the estimated velocity error growth due to transient accelerometer errors. The velocity error growth profile is calculated such that the total error, as obtained from combining the velocity error growth values with the velocity error due to constant accelerometer errors, matches the velocity error measured at the end of the stationary period (e.g., SP₂ for MP₁ in FIG. 5).

In some implementations, the DEC 121 is configured to calculate the error growth values by applying one or more assumptions to the velocity error, including but not limited to: (i) that all of the velocity error is accumulated at the start of movement period (i.e., where shocks and vibrations that are likely to produce transient errors may be most common); (ii) that the velocity error accumulates ratiometrically with velocity increase; and (iii) that the velocity error increases as a function of acceleration magnitude and/or frequency (e.g., where the DEC 121 generates a function of velocity error over time by performing a sliding Fast Fourier Transform (FFT) over a window of the data).

At step 646, the DEC 121 corrects the accelerometer data values of the moving period according to the estimated velocity error growth value. In some embodiments, the DEC 121 is configured to apply a scaling factor to the velocity error values produced by the determined error growth value such that the corrected velocity (as derived from the corrected accelerometer values) at the end of the movement period matches to a known or measured error value.

Multiple Accelerometers with Varying Capability

In some scenarios the movement of the MD 104 is subject to shocks and/or vibration events. Shocks or vibrations occurring during movement of the MD 104 may cause an accelerometer of the sensing component 126 to exceed its dynamic range, bandwidth, or both. In some instances the DEC 121 may be unable to detect any output from an otherwise high accuracy accelerometer in the presence of a shock or vibration event, thereby resulting in errors in the accelerometer data.

The accelerometer(s) of sensing component 126 may be configured with an increased dynamic range and/or bandwidth to enable the sensor(s) to generate outputs corresponding to movements of the MD 104 even in the presence of the shock and/or vibration events. However, this results in a loss of accuracy in output values generated in the absence of any shock or vibration (i.e., in periods when the MD 104 experiences a substantially linear movement during extraction). This is because an accelerometer with lower dynamic range and/or bandwidth is typically able to provide acceleration measurements with increased accuracy compared to a similar sensor that is configured with a higher range and/or bandwidth.

In some configurations, the sensing component 126 of the MD 104 includes a plurality of accelerometers with different detection capabilities. Specifically, the plurality of accelerometers are collectively configured such that the dynamic ranges and/or bandwidths of the accelerometers vary (i.e., no two accelerometers of the sensing component 126 have identical values). The DEC 121 is configured to generate, in a time period, accelerometer data by using output data generated by a first accelerometer of the plurality of accelerometers, the first accelerometer being dynamically selected based on the motion experienced by the MD 104 in the time period and the detection capabilities of the plurality of accelerometers.

In some embodiments, the DEC 121 is configured to process the accelerometer output, or absence of an output, at each sample point during a movement period to determine accelerometer data representing the movement of the MD 104. For example, the DEC 121 may take, as the generated accelerometer data, the output of the accelerometer with the lowest dynamic range and/or bandwidth that is capable of generating reliable data at the particular sample time instant of motion. Alternatively, the DEC 121 may calculate accelerometer data values as a weighted average of, any two or more of the accelerometer outputs based on the expected accuracy of each accelerometer during the movement period, or a portion of the movement period.

The DEC 121 may be configured to determine the accuracy and/or reliability of an accelerometer output at a given sample time instant by comparing the values of the accelerometer output magnitude and/or frequency to one or more of: (i) a manufacturer supplied specification of the dynamic range and/or bandwidth; and (ii) a sensitivity function indicating acceleration magnitude and frequency as determined by conducting validation tests on the accelerometer(s). For example, the DEC 121 may be configured to compare the output of each accelerometer to a reliability or accuracy threshold, where the comparison is performed according to ascending dynamic range and/or bandwidth. By selecting the first output value that satisfies the comparison check as the sampled accelerometer data, the DEC 121 achieves a degree of resilience against shock and vibration effects (i.e., by using data output by a higher range/bandwidth accelerometer at times when these effects occur) while prioritizing the use of more accurate accelerometer data in the absence of these effects.

In other embodiments, the DEC 121 may be configured to utilize another means to generate the adjusted accelerometer data to cause corresponding velocity data to indicate that the MD 104 is stationary at the end of the movement period. For example, the DEC 121 may process the accelerometer data to determine an analytical function of the velocity with the constraint that the function has zeroed velocity data points at the start and end of the movement period. The determined velocity function is then processed to regenerate the adjusted accelerometer values, enabling the DEC 121 to proceed to step 308 without iteration.

At step 308, the DEC 121 generates corrected depth measurement values d(t) of the borehole 101 based on the corrected (i.e., relative and velocity compensated) acceleration values. In the described embodiments, the depth measurements d(t) are produced for each measurement of accelerometer data, and each measurement indicates a depth of the MD 104 along the axis of the borehole 101 at the sample time.

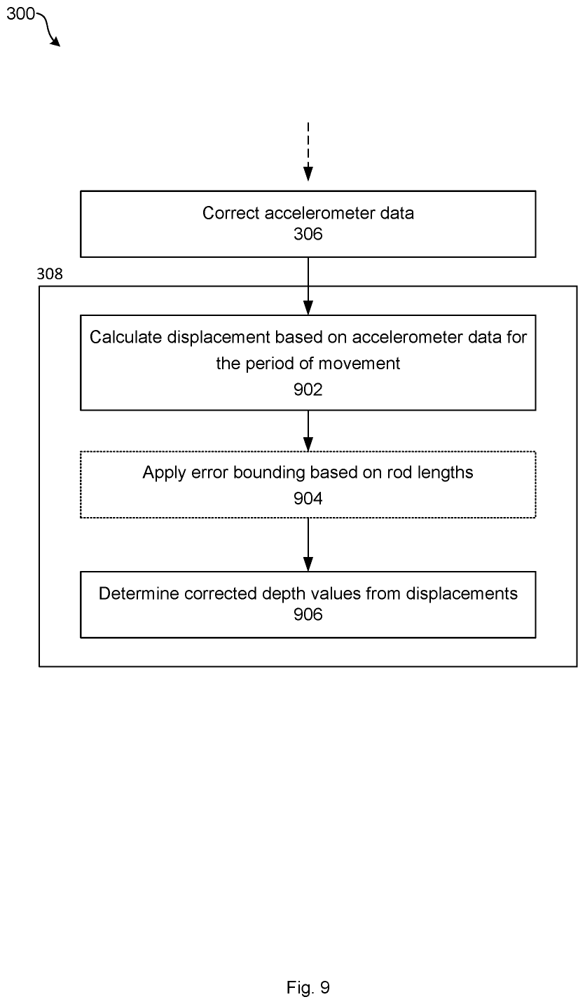

FIG. 9 illustrates the process 308 for the generation of corrected depth measurements according to the described embodiments. The DEC 121 is configured to generate the corrected depth measurement values d(t) from a plurality of displacement values s(t) of the MD 104. The displacement values s(t) of the MD 104 are generated incrementally in real-time or in post processing for each successive movement period MP after the corresponding generation of the corrected accelerometer data (i.e., at step 306).

At step 902, the DEC 121 performs a double integration operation in the discrete time domain to calculate the displacement values from the accelerometer values. In the described embodiments, the displacement values s(t) represent the displacement of the MD 104 at time t, from its initial position A′ at the end of the borehole 101. In embodiments where the acceleration data processed by the DEC 121 are scalar values, the displacement values s(t) indicate the distance travelled by the MD 104 at time t through the borehole 101, where s(0)=0 at the initial position A′.

In some embodiments, the DEC 121 is configured to utilize prior knowledge of the drilling workflow, and/or of the properties of the borehole 101, to apply error bounding on the displacement values s(t) determined for a particular movement period MP. For example, in the described embodiments the depthing module 130 is configured to utilize knowledge of the lengths of the drill rods 146a-c, and the sequence in which the drill rods are removed from the borehole 101.

In other embodiments, the depthing module 130 may be configured to use measurements about the formation of the strata obtained during the deployment of the MD 104 into the hole 101 in order to perform, or contribute to, the error bounding. For example, some embodiments may be configured to generate gamma readings during deployment that is used to cross correlate with data obtained from other sensors of the geo-sensing module 132 on during drill string extraction.

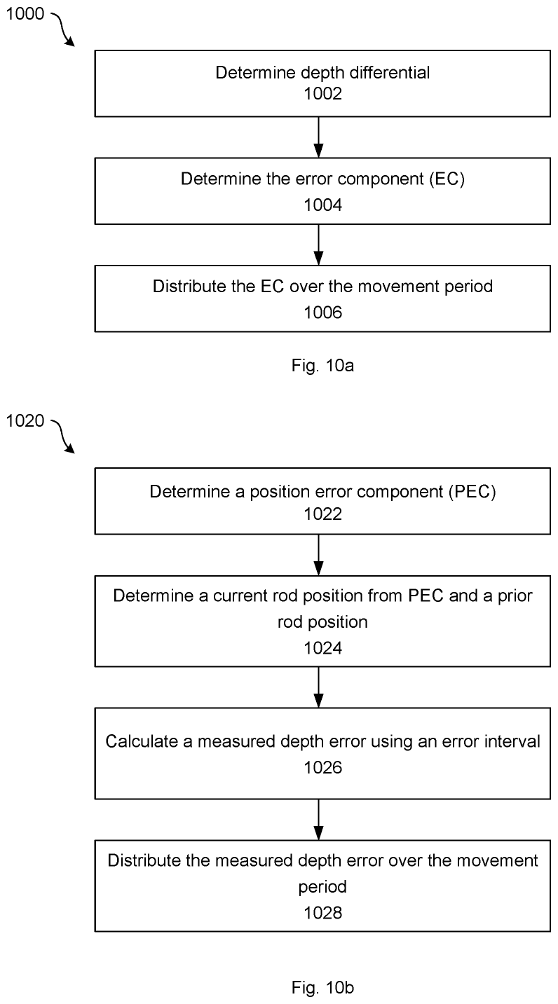

FIG. 10a illustrates the sub-steps of an error bounding process 1000 performed by the DEC 121 to correct determined displacement values using knowledge of drill rod length. At step 1002, the DEC 121 determines a depth differential value s_{diff} as the difference between respective displacement values at the end and at the start of the movement period. For example, for a movement period MP=(t₁, t₂), the depth differential is given by s_{diff}=s(t₂)−s(t₁). The depth differential represents the distance travelled by the MD 104 during the movement period MP (i.e., between the stationary periods SP₁ and SP₂).

At step 1004, the DEC 121 determines an error component (EC) by subtracting, from the depth differential value s_{diff}, a length L of the corresponding drill rod extracted from the borehole 101 during the movement period MP: EC=s_{diff}−L_{rod}. Although the rod lengths are generally 3 m, 6 m, and 9 m, any arbitrary length of drill rod may be used for any one of the rods 146a-c of string 146.

In some embodiments, error bounding process involves checking the total displacement calculated for the MD 104 over the movement period MP against the length of the rod 146a-c that was known to be removed as a result of the movement period MP. This enables the DEC 121 to bound the calculated displacement to the rod length and thereby eliminate large errors associated with the rod pull.

In other embodiments, the error bounding process may alter the individual displacement values determined within each movement period MP that is associated with the extraction of one of the drill rods 146a-c of drill string 146 from the borehole 101. For example, in the drill string extraction process shown in FIG. 4b, a movement period in which the MD 104 moves from position A′ to position P results in the extraction of rod 146c from borehole 101. The s_{diff} value of 3.18 m is the measured distance (i.e., as derived from the accelerometer values produced by MD 104) between positions A′ and P along the borehole axis. For a length L_{146c}=3 m for rod 146c, the error component is given by C=s_{diff}−L_{rod}=0.18 m.

At step 1006, the DEC 121 is configured to distribute the determined error component (EC) over the movement period MP. In the described embodiments, distributing the error component over the movement period MP includes adjusting the measured displacement values s(t) of the movement period MP by: i) normalizing the EC value by the number of displacement measurements corresponding to the movement period; and ii) subtracting the normalized EC value from each displacement measurement value of the movement period. For example, with reference to FIG. 4b consider that displacement measurements s(t) are produced at 9 sample instances in the movement period including at the end time t₂ (shown in FIG. 5). The normalized EC value is given by E̅C̅=EC/9=0.02, and the adjusted displacement values with bounded error are given by \tilde{s}(t)=s(t)−E̅C̅=s(t)−0.02 for t∈MP=[t₁, t₂].

The DEC 121 is configured to perform the error bounding process 1000 in the scenarios where drill string extraction involves the drill rods being pulled through the same distance (e.g., where the top of each rod is pulled up to the same position each time prior to detachment). Although consistent rod pulls are desirable, this may be impractical or inconvenient to achieve, particularly in operations where the drill string extraction is performed entirely by human operators.

A non-zero variation in the surface rod position after successive rod pulls causes an error component to be introduced into the depth measurements (referred to as “stick-up error”). FIG. 10b illustrates an alternative error bounding process 1020 that accounts for stick-up error by tracking the current rod position at the surface and using a pre-determined error interval to determine a measured depth error.

In some embodiments, the current rod position at the surface is evaluated relative to the collar of the borehole 101, and indicates a distance above the collar of a predetermined portion of the rod (such as the top). Prior to the commencement of the drill string extraction, an initialization process is performed which involves setting the value of the current rod position to zero. The drill string is positioned to achieve alignment of first drill rod. Alignment of the rod is performed between a predetermined position on the rod (e.g., the top) and the collar (or other reference point, as described below).

Drill string extraction commences and the drill rod is pulled through the surface. At step 1022, the DEC 121 determines a position error component PEC by calculating a change in position of the drill rod at the surface of borehole 101. The change in position is calculated as the difference between the measured displacement and the nominal rod length, as described for the calculation of EC in error bounding process 1000.

At step 1024, the DEC 121 determines a new current rod position by adding the position error component PEC to the previous current rod position representing the position of the drill rod at the surface prior to the pull (the “prior rod position”). The DEC 121 is configured to calculate, at step 1026, a measured depth error value using an error interval. The error interval is defined by predetermined lower and upper bounds. The DEC 121 compares the current rod position to the lower and upper bound values and calculates the measured depth error value based on whether the current rod position is: (i) within the error interval, where the measured depth error value is set to zero; (ii) below the lower bound or above the upper bound, where the measured depth error value is set to a difference between the current rod position and the respective lower or upper bound.

At step 1028, the DEC 121 is configured to distribute the determined measured depth error over the movement period MP. In some embodiments, distributing the measured depth error component over the movement period MP includes adjusting the measured displacement values s(t), as described above for error bounding process 1000.

In some embodiments, the lower and/or upper bound of the error interval are configurable to enable dynamic control over the accuracy of the associated error bounding process 1020. For example, the error interval values may be determined in response to a validation test involving the calculation of one or more measures of the statistical variance in the current rod position after rod removal during drill string extraction. In some embodiments, the DEC 121 is configured to set the lower and/or upper bound values in response to control commands provided to the MD 104 via the DMA.

The accuracy of the error bounding process 1020 may be improved by reducing the statistical variance of the rod position after each rod pull. This enables the lower and/or upper bounds of the error interval to be adjusted to reduce the size of the interval. Reducing the size of the error interval reduces the value of the measured depth error applied to correct the depth estimates over a given movement period.

The statistical variance of the rod position between successive pulls is reduced by increasing the accuracy and consistency with which rods are aligned with a predetermined reference point following each pull. In an example configuration, the reference point is defined by a “reference indicator” associated with the drill rig, or other structure of the drilling apparatus 140 (e.g., the drilling device 142), through which the rods of the drill string pass during removal. The reference point may be set to the collar position, or to any arbitrary point with respect to the collar of the borehole 101.

The type and form of the reference indicator varies depending on the configuration of the drill apparatus 140 and/or drill string 146. For example, the reference indicator may be a fixed element of the drill rig 141, such as a physical attachment, or marking, applied to the drill rig 141 (such as a paint mark, bolt, or other physical component). FIGS. 4g and 4h illustrate the use of a reference indicator in the form of a fixed notch or bolt 149 attached to a part of the drilling apparatus to align the top of the drill rods 146a, 146b to reference point 147, which is above collar position A, during two successive pulls.

In other embodiments, the reference indicator may be any other type of guide element that can be applied to the drilling apparatus to define a reference position for accurate and consistent positional alignment with the top (or other selected part) of the rod (e.g., a visual marker from a light source, such as a laser).

The use of a reference indicator may be advantageous in configurations where drill string extraction involves a human operator physically manipulating the rods (i.e., to facilitate detachment of the current extracted rod). For example, the use of a visual reference indicator improves the ability of the operator to manually align the top (or other selected part) of the rod using hand-eye coordination.

In other examples, the reference indicator enables the operator to receive objective feedback related to the degree of alignment of the rod with the reference point. For example, the reference indicator may include one or more sensors configured to detect the top (or other part) of the rod at the reference point, and to generate an alert in response to the detection. The alert may be visual or auditory in nature, such as the illumination of an LED or the sounding of a tone to denote a correct or desired alignment of the rod with the reference point. The reference indicator may be configured to perform the detection using one or more detector elements coupled to the rod (e.g., an optical strip, or RF tag). This allows the operator to achieve more accurate alignment consistently through the rod extraction process, and without substantially decreasing the speed of the extraction operation.

In some embodiments, the alignment of a rod with the reference point is performed intermittently during the drill string extraction, rather than for every pull. For example, rod alignment with the reference indicator may be performed once every 10 to 50 rod pulls, or at one or more predetermined progression points during the rod extraction process (e.g., in response to the extraction of a percentage of the total number of rods in the string). In some embodiments, the DEC 121 prompts the operator to perform an alignment of a rod with the reference point in response to one or more alignment conditions (e.g., a maximum number of rods being extracted since the last alignment). In some embodiments, the DEC 121 is configured to enable an operator to perform rod alignments dynamically at any arbitrary time. The operator provides a notification of the completion of the ad-hoc alignment to the DEC 121 via a user interface function of the DMA.

With reference to FIG. 9, at step 906 the DEC 121 generates corrected depth measurement values from the displacement values s(t), the displacements being based on the corrected accelerometer data values. In the described embodiments, the DEC 121 calculates the displacement values s(t) in real-time after the corresponding correction of the accelerometer data incrementally for each movement period MP of the measurement process (i.e., the drill string extraction process in the described embodiments).

In some embodiments, the DEC 121 is configured to set the total measured depth D of the borehole 101 to the displacement value s(t_{N-1}), or adjusted displacement value \tilde{s}(t_{N-1}), where t_{N-1} is the final sample time instant of the measurement process (i.e., where MD 104 is at collar position A). The DEC 121 is configured to generate corresponding depth values d(t) based on the total measured depth D as d(t)=D−s(t) for each sample time instant over all of the movement periods, after the completion of the measurement process (i.e., once the value of D is determined).

In other embodiments, the DEC 121 is configured to generate a corrected depth measurement d(t) dynamically after the generation of the corresponding displacement s(t) at each sample time instant. The DEC 121 is provided with an indication of the total depth D of the borehole 101 prior to the commencement of the measurement process. For example, during initialization the depthing module 130 may be initialized with a total depth estimate provided by an external source, such as an encoder 117 of the deployment mechanism 109 used to deploy the MD 104 into the borehole 101.

The DEC 121 generates a series of depth measurements d(tᵢ₌₀), d(tᵢ₌₁), . . . , d(t_{i=N-1}) indicating the depth of the MD 104 within the borehole 104 at the times at which sample i=0, 1, . . . N−1 of the accelerometer data measurements are generated. The generated depth measurements may be resolved against corresponding values of other data sampled from the borehole 101. For example, in some embodiments, the geo-sensing module 122 of the MD 104 is configured to generate geological measurement data at times corresponding to the sample times of the depth data. The corrected depth values d(t) generated by the depthing module 130 of the MD 104 may be resolved against the geological data measurements to enable a user of the MD 104 to perform location profiling of geological features with improved accuracy. The generation of corrected depth measurements according to the methods and processes described above thereby provides advantages to a user of the MD 104, at least by enhancing the operation of other data sensing components and/or operations (such as geo-sensing module 132).

In some embodiments, the corrected depth data generated by the MD 104 is resolved against depth data obtained from another source, such as for example from the encoder 117 configured to measure an amount of wireline used to deploy the MD 104 downhole during measurement. Differences in the depth values generated by the MD 104 and the other source may be used to perform corrective operations on the functionality of the MD 104 and/or the other source.

### Modes of Processing

The described embodiments relate to “on-device” processing in which the MD 104 is configured to perform all computational operations associated with processing the accelerometer data, and subsequently generating corrected depth measurement values. Further, the MD 104 may be configured to correct accelerometer data generated during the measurement process (i.e., during drill string extraction) in real-time. For example, the DEC 121 may be configured to correct the accelerometer data obtained during movement period MP (a(t), t∈MP=(t₁, t₂)) when the MD 104 comes to rest during the second stationary period commencing at t₂.

The ability to perform real-time correction is enabled by the use of the drill string removal to control the measurement process. As the drill string, and therefore the MD 104, is held stationary during the detachment of a drill rod from the drill string, the detachment provides an opportunity for conducting the computations required to correct the acceleration values (i.e., according to the compensation methods discussed herein). Consequently, in response to the completion of the measurement process, i.e., when the drill string extraction completes, the MD 104 has, stored in memory 125, a complete set of corrected accelerometer data describing the movement of the MD 104 through the borehole.

As an alternative, in the on-device mode of operation the depthing module 130 may be configured to delay the processing of accelerometer data (and/or other inertial data) obtained during the measurement process. In this embodiment, the inertial data obtained for each movement period is corrected sometime after the retrieval of the MD 104 at the surface (after the drill string extraction is completed, and MD 104 exits the borehole 101). The DEC 121 logs, to the memory 125, raw inertial data (and optionally geological data) at corresponding sample times. The raw data values are processed to perform incremental error correction (according to the methods described above).

Delaying the processing of the measured data may be advantageous by decoupling the data measurement process from the data correction process. For example, this may enable a user of the MD 104 to perform some operation(s) on the raw data (e.g., copying, analysis, visualization, etc.), and to selectively direct the MD 104 (via the DMA) to correct the depth measurements based on the operations. In response to the completion of the data correction processing, the MD 104 has stored, in memory 125, a complete set of corrected accelerometer data describing the movement of the MD 104 through the borehole 101, and corresponding corrected depth measurements.

In other embodiments, the MD 104 is configured to enable off-device processing, where the corrected depth measurement values, and/or corrected accelerometer data, are generated by the another device. For example, the MD 104 may be configured to transmit the logged raw accelerometer data values to the external system 112 in response to a direction, or command, received from the system 112 via the DMA. The external system 112 produces the corrected depth measurements by performing the accelerometer data correction and depth measurement generation operations on local hardware.

### Obtaining Depth Registered Geological Data Via the Drilling Workflow

The embodiments described herein above illustrate one exemplary approach of determining the depth of a measurement device (MD 104) within a borehole (101) by utilizing the drill rod extraction process of a drill string disposed within the hole 101. It will be appreciated, that in the foregoing modes of determining and/or correcting the depth measurement, the geological sensor data continuously collected during the drill rod extraction process, can be correlated to the corrected depth measurement data.

In one aspect, a geological surveying system is configured to obtain depth corrected geological data of the borehole 101 by utilizing the drilling workflow involving the extraction of the drill string 146. In an exemplary embodiment, the geological surveying system includes a MD 104 configured to perform geological measurement. A drill string monitoring system is implemented to determine depth measurements of the MD 104 within the borehole 101. A geological analysis device in the form of a computing device is configured to register depths, as determined from the depth measurements, against the geological measurement values. The generation of both the geological measurements and the depth measurements are enabled by the movement of the MD 104 through the borehole 101 during drill string extraction (e.g., via the correction of accelerometer data obtained from the MD 104 in accordance with any of the methods described above).

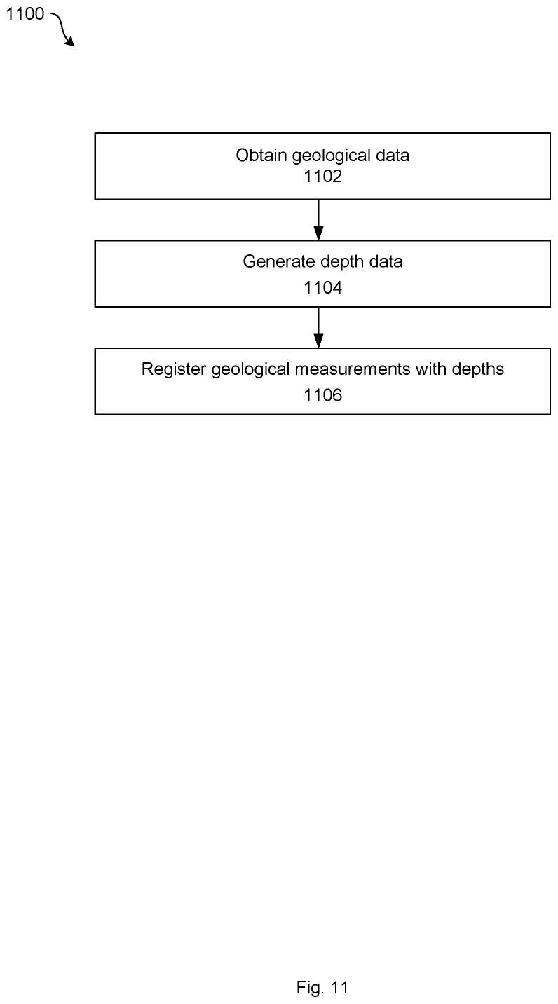

FIG. 11 illustrates a illustrates a flow diagram of a method 1100 for obtaining depth registered geological data using measurement device 104 coupled to the drill string 146 disposed within borehole 101. At step 1102, geological data is obtained from MD 104. In the described embodiments, the MD 104 is configured to generate geological measurement values from a geological sensing component, such as geo-sensing module 132 (as shown in FIGS. 2b and 2d).

In some embodiments, the MD 104 also includes a timing module configured to generate timing data in relation to the geological measurement values produced by the geo-sensing module 132. For example, the timing module can be configured to generate a series of geological timestamped data values indicating a time at which the one or more geological measurement values are generated by the geo-sensing module 132.

In some embodiments, the MD 104 is configured generate, at each time instant for which a geological measurement value is produced by the geo-sensing module 132, a movement indication value indicating whether the MD 104 is stationary within the borehole 101 (e.g., as a binary value). The movement indication value may be generated by the DEC 121 (i.e., by performing movement period determination as described above), or by one or more other modules configured to detect a movement, and/or lack of movement, of the MD 104 relative to the borehole 101 (e.g., a Stationary Period Detector (SPD)). This enables the MD 104 to generate geological data including the geological measurement values, the corresponding timestamped values at which each geological measurement was taken, and/or the corresponding indications of whether the MD 104 was stationary in the borehole at each geological measurement.

At step 1104, depth data is generated including one or more depth measurement values indicating the depth of the MD 104 in the borehole 101. In the described embodiments, a drill string monitoring device is configured to generate the depth measurement values by detecting the movement of a drill rod 146a-c of the string 146 at the surface, and preferably at or about the collar of the borehole 101, during the drill string extraction process. In some embodiments, the drill string monitoring device may be mounted on or about the drilling rig 141, such as on the drill head, to enable the device to have a line of sight, either directly or indirectly, to the drill string 146 in order to determine movement of the drill string 146 within the borehole 101 and/or as it is extracted from the borehole 101 as part of the drill string 146 extraction process.

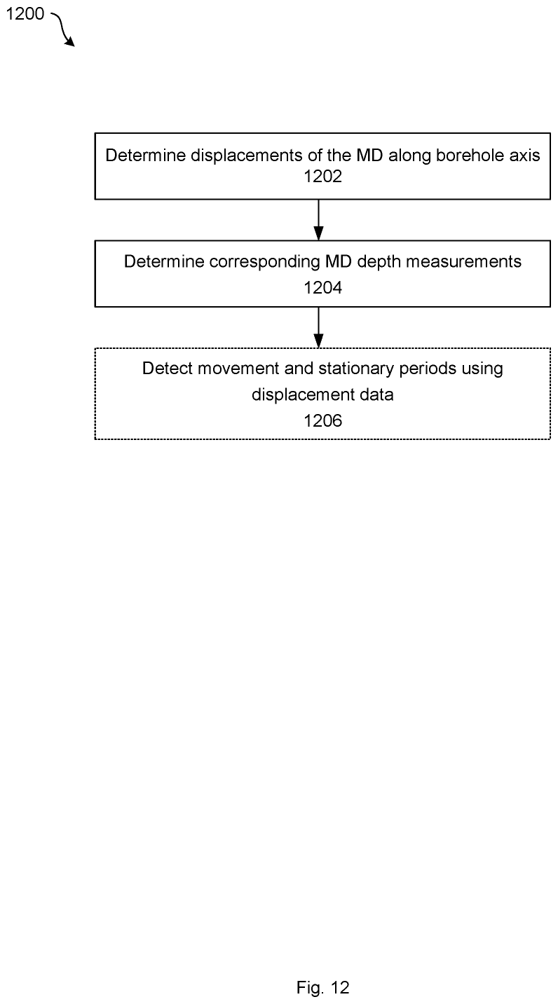

FIG. 12 illustrates an exemplary approach to generating the one or more depth measurement values comprising, at step 1202, determining, via the drill string monitoring device, displacement and/or movement data indicating one or more displacements and/or movements of the MD 104 along the axis of and/or within the borehole 101. For example, in some embodiments the displacement is determined by determining a length of the drill string 146 that has passed through the collar. In other examples, the movements indicate that the drill string 146 has moved up and down within the borehole 101 in accordance with attempts to remove the drill string 146 from the borehole 101 as part of the extraction process. The drill string monitoring device is arranged or positioned relative to the borehole 101 in a manner to detect such movement (as described above).

In some embodiments, the displacement data is generated by a time-of-flight high speed LiDAR Distance Gauge System (DGS). The DGS is mounted to the drilling rig 141 and is configured to detect a corresponding target (e.g., a light reflective target mirror) mounted on the rod pulling mechanism used to drive the drill string extraction. The DGS is configured to emit a light beam aimed at the target attached to the pulling mechanism which reflects to a receiver in the DGS. The DGS is configured to determine the distance moved by the pulling mechanism based on the relationship between the constant speed of light in air and the time between emitting the beam and receiving the reflected signal (as measured continuously at a high clock speed). The calculated distance of movement of the pull mechanism corresponds to the length of drill string 146 moved through the borehole collar and the displacement of the MD 104 within the borehole 101.

The DGS is configured to record distance (i.e., displacement) values as incremental changes relative to the last recorded distance (depth) continuously during the drill string extraction process. At step 1204, the determined displacements are processed to generate corresponding depth measurement values of the MD 104 within the borehole 101. For example, the DGS is configured to maintain a depth counter value indicating the depth associated with the most recent distance sample obtained from the drill string. In response to the generation of each distance value, the depth counter is incremented with the newly generated distance and the result is logged as the depth measurement of the MD 104 at the time instant.

In some embodiments, the DGS is configured to detect, based on the displacement data, one or more movement periods and corresponding stationary periods of the MD 104 within the borehole 101 (i.e., at step 1206). For example, a stationary period may be detected in response to a displacement reading of substantially zero for a number of samples, or in response to a series of readings of alternating sign (indicating that movement is being applied to correct a stuck string). The movement periods, being the periods in which the drill string moves through the collar, then each correspond to the extraction of a portion of the string (i.e., a drill rod) from the borehole 101.

In other embodiments, generation of the depth data includes the processing of corrected accelerometer data, as produced by the sensing component 126 of the MD 104. As described above, the corrected accelerometer data is processed by the depthing module 130 to generate (corrected) depth measurement values, where the depth measurement values and corresponding time data is provided to the analysis device as the depth data.

Referring back to FIG. 11, at step 1106 the geological analysis device registers each of the one or more geological measurement values (obtained from the MD 104) with a corresponding depth value by correlating the generated geological measurement values with the depth measurement values. The analysis device calculates a depth to be registered with, or assigned to, each geological measurement by performing time synchronization of the time values of the depth and geological data. In some embodiments, for example where the timestamps are recorded from a common reference time, synchronization involves matching the geological measurement with the depth measurement most closely recorded in real-time.

In other embodiments, the geological data and depth data may contain timestamp values generated from different reference times. In such embodiments, the analysis device is configured to perform synchronization by matching corresponding movement, and/or stationary, periods determined during the generation of the geological data and the depth data. The determination of a corresponding depth value, representing an indication of the depth of the MD 104 within the borehole 101, for each geological measurement results in the formation of a depth registered geological dataset.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A measurement device (MD) for measuring depth within a borehole when coupled to a drill string disposed within the borehole, the MD comprising:
a sensing component including, at least, a plurality of accelerometers configured to generate accelerometer data as the MD moves through the borehole; and
a controller component configured to:
correct the accelerometer data generated by the sensing component by:
repeatedly, for each of a plurality of movement periods in which the MD moves within the borehole:
altering the accelerometer data generated during the movement period to reduce errors associated with the movement of the MD, based on the accelerometer data generated in at least one of a first stationary period of the MD and a second stationary period of the MD, the first and second stationary periods occurring respectively before and after the movement period,
wherein each of the plurality of movement periods corresponds to extraction of a portion of the drill string from the borehole; and
generate, based on the corrected accelerometer data, one or more corresponding corrected depth measurement values of the MD in the borehole.

2. The device of claim 1, wherein the drill string disposed within the borehole comprises one or more interconnected drill rods, and each movement period ends with the extraction of one of the drill rods from the borehole.

3. The device of claim 2, wherein the accelerometer data is corrected incrementally for each successive movement period of the plurality of movement periods when the MD comes to rest during the second stationary period.

4. The device of claim 3, wherein the corrected depth measurement values are generated from a plurality of displacement values of the MD,
wherein the displacement values are generated incrementally for each successive movement period after the corresponding correction of the accelerometer data.

5. The device of claim 1, wherein each of the plurality of movement periods is determined by processing the accelerometer data generated by the MD in a signal window to determine one or more statistical metrics indicating one or more time periods of relatively low accelerometer output.

6. The device of claim 5, wherein determining each respective movement period further includes:
obtaining output data from an accelerometer of the MD;
calculating one or more statistical metrics derived from a window of the output data;
determining a quiet period of the output data by comparing the calculated one or more statistical metrics to one or more corresponding predetermined values;
determining one or more null estimate values of the accelerometer by processing the output values of at least the determined quiet period;
determining an indication of movement of the MD by applying the null estimate value to correct the output data; and
in response to a change in the indication of movement of the MD over time, determining a start time or an end time of the respective movement period.

7. The device of claim 1, wherein altering the accelerometer data includes performing velocity error compensation to generate adjusted accelerometer data to cause corresponding velocity data to indicate that the MD is stationary at the end of the movement period.

8. The device of claim 7, wherein performing velocity error compensation includes:
(a) determining, based on accelerometer data during the movement period, a non-zero velocity of the MD at the end of the movement period;
(b) incrementally adjusting the accelerometer data to cause a corresponding adjustment of an indication of the velocity during, and at the end of, the movement period; and
(c) iteratively repeating steps (a) and (b) until the velocity of the MD at the end of the movement period is zeroed.

9. The device of claim 8, wherein altering the accelerometer data includes determining an indication of gravity from the accelerometer data determined during the first or second stationary periods of the movement period.

10. The device of claim 9, wherein altering the accelerometer data includes compensating for an accumulated error of the accelerometer data by computing a measure of the stable total gravity inclusive of the MD attitude.

11. The device of claim 1, wherein the sensing component further includes a plurality of gyroscopes configured to generate gyroscope data corresponding to the accelerometer data, and
wherein the controller component is further configured to:
correct the gyroscope data generated by the sensing component by performing one or more of:
a) resetting the starting dip angle to that of the stable accelerometer sensed value during the first stationary period; and
b) determining a change in the dip angle of the gyroscope data to the corresponding accelerometer data immediately after the movement period, and applying the change in the dip angle ratiometrically to the dip angle values produced by the gyroscope data over the movement period.

12. The device of claim 11, wherein correcting the gyroscope data includes performing attitude error compensation by:
determining an accumulated error due to a gyroscope bias induced drift of one or more of the plurality of gyroscopes, based on the difference in attitude values of the corresponding gyroscopes generated in the first and second stationary periods; and
retroactively and evenly distributing the determined accumulated error over the gyroscopic attitude values generated during the movement period,
such that the resulting gyroscopic attitude values generated just prior to the second stationary period coincide with accelerometer attitude values generated during the second stationary period.

13. The device of claim 4, wherein generating the depth measurement values includes, for each movement period:
determining a depth differential value as the difference between respective displacement values generated at the start and the end of the movement period;
determining a depth error component by subtracting, from the depth differential value, a length of the corresponding drill rod extracted from the borehole during the movement period; and
distributing the depth error component over the movement period.

14. The device of claim 13, wherein distributing the depth error component over the movement period includes:
normalizing the depth error component by a number of displacement measurements corresponding to the movement period; and
subtracting the normalized depth error component from each displacement measurement value of the movement period.

15. The device of claim 1, wherein each of the plurality of accelerometers are configured with different detection capabilities, the detection capability of each accelerometer being defined by one or more of: a dynamic range value; and a bandwidth value, and
wherein the accelerometer data is generated, in a time period, by using output data of a first accelerometer of the plurality of accelerometers, the first accelerometer being selected based on the motion experienced by the MD in the time period and the detection capabilities of the plurality of accelerometers.

16. A method for correcting accelerometer data obtained from a measurement device (MD) coupled to a drill string disposed within a borehole, the method comprising:
i) determining a movement period in which the MD moves within the borehole;
ii) altering the accelerometer data generated during the movement period to reduce errors associated with the substantially linear movement of the MD, based at least on accelerometer data generated in at least one of a first stationary period of the MD and a second stationary period of the MD, the first and second stationary periods occurring respectively before and after the movement period; and
iii) repeating (i) and (ii) for one or more further movement periods in which the MD is within the borehole, wherein each of the plurality of movement periods corresponds to extraction of a portion of the drill string from the borehole.

17. The method of claim 16, wherein the accelerometer data is corrected incrementally in real-time or during post processing for each successive movement period of the plurality of movement periods when the MD comes to rest during the second stationary period.

18. The method of claim 16, wherein the corrected accelerometer data is processed to generate one or more corresponding corrected depth measurement values of the MD in the borehole.

19. The method of claim 18, wherein the corrected depth measurement values are generated from a plurality of displacement values of the MD,
wherein the displacement values are generated incrementally for each successive movement period after the corresponding correction of the accelerometer data.

20. The method of claim 16, wherein altering the accelerometer data includes performing velocity error compensation to generate adjusted accelerometer data to cause corresponding velocity data to indicate that the MD is stationary at the end of the movement period.

21. The method of claim 20, wherein performing velocity error compensation includes:
(a) determining, based on accelerometer data during the movement period, a non-zero velocity of the MD at the end of the movement period;
(b) incrementally adjusting the accelerometer data to cause a corresponding adjustment of an indication of the velocity during, and at the end of, the movement period; and
(c) iteratively repeating steps (a) and (b) until the velocity of the MD at the end of the movement period is zeroed.

22. The method of claim 18, wherein generating the depth measurement values includes, for each movement period:
determining a depth differential value as the difference between respective displacement values generated at the start and the end of the movement period;
determining a depth error component by subtracting, from the depth differential value, a length of the corresponding drill rod extracted from the borehole during the movement period; and
distributing the depth error component over the movement period.

23. The method of claim 22, wherein distributing the depth error component over the movement period includes:
normalizing the depth error component by a number of displacement measurements corresponding to the movement period; and
subtracting the normalized depth error component from each displacement measurement value of the movement period.

24. An apparatus for measuring depth within a borehole, including:
a measurement device (MD) coupled to a drill string disposed within the borehole; and
a data processing device having:
a communications interface to receive data from at least the MD;
at least one computer processor to execute program instructions; and
a memory, coupled to the at least one computer processor, to store program instructions for execution by the at least one computer processor,
wherein the MD is configured to:
generate, by a sensing component including a plurality of accelerometers, accelerometer data as the MD moves through the borehole; and
transmit, to the data processing device, the generated accelerometer data; and
wherein the data processing device is configured to:
receive the accelerometer data from the MD; and
correct the accelerometer data; and
generate, based on the corrected accelerometer data, one or more corresponding corrected depth measurement values of the MD within the borehole,
wherein the correction of the accelerometer data is performed according to the method of claim 16.

25. A method for obtaining depth registered geological data using a measurement device (MD) coupled to a drill string disposed within a borehole, the method comprising:
obtaining, from a geological sensing component of the MD, geological data including one or more geological measurement values of the borehole as the MD moves through the borehole;
generating depth data indicating one or more depth measurement values of the MD in the borehole; and
registering each of the one or more geological measurement values with a corresponding depth determined from the generated depth measurement values, wherein the generation of the one or more depth measurement values comprises correcting accelerometer data obtained from the MD in accordance with the method of claim 16.

26. The method of claim 25, wherein generating the depth data comprises:
i) determining, via a drill string monitoring device, displacement data indicating one or more displacements of the MD along the axis of the borehole; and
ii) determining corresponding depth measurement values of the MD within the borehole from the determined displacements,
wherein the displacement data is generated by measuring the movement of the drill string at, or about, a region of a surface of the borehole.

27. The method of claim 26, wherein generating the depth data comprises:
detecting, based on the displacement data, one or more movement periods and corresponding stationary periods of the MD within the borehole,
wherein each of the movement periods corresponds to extraction of at least a portion of the drill string from the borehole.

28. (canceled)

29. The method of claim 25, wherein registering each of the one or more geological measurement values with a corresponding depth comprises performing time synchronization of the geological measurement values with the depth measurement values, by matching corresponding movement periods determined during the generation of the geological data and the depth data.

30. An apparatus for obtaining depth registered geological data of a borehole, including:
a measurement device (MD) coupled to a drill string disposed within the borehole; and
a data processing device having:
a communications interface to receive data from at least the MD;
at least one computer processor to execute program instructions; and
a memory, coupled to the at least one computer processor, to store program instructions for execution by the at least one computer processor,
wherein the MD is configured to:
generate, by a geological sensing component, geological data including one or more geological measurement values of the borehole as the MD moves through the borehole; and
transmit, to the data processing device, the generated geological data; and
wherein the data processing device is configured to:
receive the geological data from the MD; and
generate depth data indicating one or more depth measurement values of the MD in the borehole; and
register each of the one or more geological measurement values with a corresponding depth determined from the generated depth measurement values,
wherein the generation of the one or more depth measurement values comprises correcting accelerometer data obtained from the MD in accordance with the method of claim 16.
